(19) United States
(12) Patent Application Publication
(10) Pub. No.: US 2024/0216814 A1
(43) Pub. Date: Jul. 4, 2024

(54) VIRTUAL OBJECT COPY

(71) Applicant: Tencent Technology (Shenzhen) Company Limited, Shenzhen (CN)

(72) Inventors: Nu ZHANG, Shenzhen (CN); Meng YIN, Shenzhen (CN); Xinbo ZHOU, Shenzhen (CN)

(73) Assignee: Tencent Technology (Shenzhen) Company Limited, Shenzhen (CN)

(21) Appl. No.: 18/604,119

(22) Filed: Mar. 13, 2024

Related U.S. Application Data
(63) Continuation of application No. PCT/CN2023/118304, filed on Sep. 12, 2023.

(30) Foreign Application Priority Data
Oct. 13, 2022 (CN) 202211252977.3

(51) Int. Cl. A63F 13/58; A63F 13/60; A63F 13/798

(52) U.S. Cl. CPC A63F 13/58; A63F 13/60; A63F 13/798

(57) ABSTRACT

In a game processing method, a request is received from a user of a second virtual object to perform an object copy function on a first virtual object. A first game skill control element is displayed in a control region of the second virtual object in a game interface based on the request. The first game skill control element is associated with a first game skill of the first virtual object. A display of the second virtual object in the game interface is switched from a second object image of the second virtual object to a first object image of the first virtual object based on the request. The second virtual object is controlled to perform the first game skill based on a user interaction with the first game skill control element in the control region of the second virtual object in the game interface.

### RELATED APPLICATIONS

The present application is a continuation of International Application No. PCT/CN2023/118304, filed on Sep. 12, 2023, which claims priority to Chinese Patent Application No. 202211252977.3, filed on Oct. 13, 2022. The entire disclosures of the prior applications are hereby incorporated by reference.

### FIELD OF THE TECHNOLOGY

This disclosure relates to the field of computer technologies, including to a game processing method and apparatus, a computer device, a computer-readable storage medium, and a computer program product.

### BACKGROUND OF THE DISCLOSURE

With the development of the Internet, online entertainment forms become increasingly diversified. In particular, games are developed extremely rapidly, and gameplay of the games also becomes increasingly diversified.

When a game battle is performed, for example, when a dungeon mission or player competition is performed, a quantity of players participating in each game battle is limited, which means that a player needs to choose an appropriate object type of players to form a team during a game battle to satisfy requirements of the game battle. However, due to the limitation on the quantity of participant players in each game battle, it may be difficult for players forming a team to satisfy the requirements of players of various object types, leading to a relatively poor game playability and a relatively undiversified game battle. As a result, the game interactivity is poor, and utilization of hardware processing resources and display resources is low.

### SUMMARY

Embodiments of this disclosure include a game processing method and apparatus, a computer device, a computer-readable storage medium, and a computer program product, which can improve interactivity of the game and utilization of hardware resources.

Technical solutions of the embodiments of this disclosure may be implemented as follows:

An embodiment of this disclosure provides a game processing method. In the game processing method, a request is received from a user of a second virtual object to perform an object copy function on a first virtual object. A first game skill control element is displayed in a control region of the second virtual object in a game interface based on the request. The first game skill control element is associated with a first game skill of the first virtual object. A display of the second virtual object in the game interface is switched from a second object image of the second virtual object to a first object image of the first virtual object based on the request. The second virtual object is controlled to perform the first game skill based on a user interaction with the first game skill control element in the control region of the second virtual object in the game interface.

An embodiment of this disclosure provides a game processing apparatus, including processing circuitry. The processing circuitry is configured to receive a request from a user of a second virtual object to perform a object copy function on a first virtual object. The processing circuitry is configured to display a first game skill control element in a control region of the second virtual object in a game interface based on the request. The first game skill control element is associated with a first game skill of the first virtual object. The processing circuitry is configured to switch a display of the second virtual object in the game interface from a second object image of the second virtual object to a first object image of the first virtual object based on the request. The processing circuitry is configured to control the second virtual object to perform the first game skill based on a user interaction with the first game skill control element in the control region of the second virtual object in the game interface.

An embodiment of this disclosure provides a computer device, including a processor, a memory, and an input/output interface, the processor being connected to the memory and the input/output interface respectively, the input/output interface being configured to receive data and output data, the memory being configured to store a computer program, and the processor being configured to invoke the computer program, to cause a computer device including the processor to perform the game processing method according to the embodiments of this disclosure.

An embodiment of this disclosure provides a non-transitory computer-readable storage medium, the computer-readable storage medium storing instructions which when executed by a processor cause the processor to perform the game processing method according to the embodiments of this disclosure.

An embodiment of this disclosure provides a computer program product or a computer program, the computer program product or the computer program including computer instructions, and the computer instructions being stored in a computer-readable storage medium. A processor of a computer device reads the computer instructions from the computer-readable storage medium, and executes the computer instructions, so that the computer device performs the method provided in the various optional implementations according to the embodiments of this disclosure. In other words, the computer-readable instructions, when executed by a processor, implementing the method provided in various optional implementations according to the embodiments of this disclosure.

By implementing the embodiments of this disclosure, the following beneficial effects may be achieved.

In the embodiments of this disclosure, a first game skill icon may be displayed in a skill display region of a game interface in which a second virtual object is located in response to an object copy operation on a first virtual object, where the first game skill icon refers to an icon of the first game skill associated with the first virtual object; an object image of the second virtual object may be switched to a first object image for display, where the first object image refers to an object image of the first virtual object; and in response to a trigger operation on the first game skill icon, the second virtual object having the first object image is controlled to cast the first game skill. Through the foregoing process, the second virtual object (that is, a virtual object controlled by a player) may morph into any other virtual object (that is, the first virtual object) through the object copy operation when participating in a game battle. When a quantity of participant players is limited, the second virtual object can still morph into a virtual object of any object type, so that a balance between different object types in the game battle is implemented, and requirements for players of various object types in the game battle are satisfied, thereby improving the playability and content richness of a game, and also improving utilization of hardware resources of a computer device. In addition, a copy function between different virtual objects is added, so that game skills of other virtual objects are experienced and object images thereof are used, thereby improving the diversity and interactivity of a game.

### BRIEF DESCRIPTION OF THE DRAWINGS

FIG. 1 is a network interaction architectural diagram of game processing according to an embodiment of this disclosure.

FIG. 2 is a schematic diagram of a game processing scenario according to an embodiment of this disclosure.

FIG. 3 is a flowchart of a game processing method according to an embodiment of this disclosure.

FIG. 4 is a schematic diagram of an object copy scenario according to an embodiment of this disclosure.

FIG. 5 is a schematic diagram of another object copy scenario according to an embodiment of this disclosure.

FIG. 6 is a schematic diagram of a display scenario of an object copy function according to an embodiment of this disclosure.

FIG. 7 is a schematic diagram of a specific procedure of game processing according to an embodiment of this disclosure.

FIG. 8A is a schematic diagram of an object copy reminder scenario according to an embodiment of this disclosure.

FIG. 8B is a schematic diagram of another object copy reminder scenario according to an embodiment of this disclosure.

FIG. 9 is a schematic diagram of a game scene prompt according to an embodiment of this disclosure.

FIG. 10 is a schematic diagram of a game processing apparatus according to an embodiment of this disclosure.

FIG. 11 is a schematic structural diagram of a computer device according to an embodiment of this disclosure.

### DESCRIPTION OF EMBODIMENTS

The technical solutions in the embodiments of this disclosure are described below with reference to the accompanying drawings. The described embodiments are merely some rather than all of the embodiments of this disclosure. Other embodiments are within the scope of this disclosure.

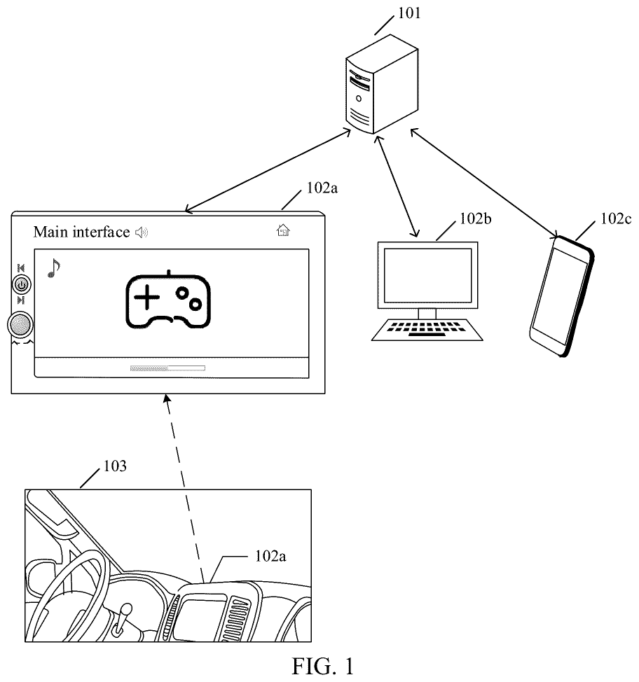

In the embodiments of this disclosure, referring to FIG. 1, FIG. 1 is a network interaction architectural diagram of game processing according to an embodiment of this disclosure. As shown in FIG. 1, computer devices may participate in a game and interact with another computer device in the game, where any computer device participating in the game (for example, a computer device 102a, a computer device 102b, or a computer device 102c) may respond to an object copy operation, obtain a game skill and an object image of a first virtual object to which the object copy operation is targeted, and update display of a game skill and an object image of a second virtual object in the computer device based on the game skill and the object image of the first virtual object. There may be one or at least two computer devices. In some embodiments, the computer device may obtain the game skill and the object image of the first virtual object through a server 101. For example, assuming that the computer device 102a responds to the object copy operation on the first virtual object, the first virtual object is a virtual object associated in the computer device 102c, and the computer device 102a may transmit an object copy request for the first virtual object to the server 101. The server 101 may obtain the game skill and the object image of the first virtual object in the computer device 102c, and broadcast the game skill and the object image of the first virtual object to each computer device. The computer device 102a may update display of the second virtual object based on the obtained game skill and object image of the first virtual object, and another computer device may also update the display of the second virtual object based on the obtained game skill and object image of the first virtual object, so as to implement synchronous updating of each virtual object and improve the synchronization and accuracy of a display effect. In some embodiments, the computer device 102a may alternatively directly obtain the game skill and the object image of the first virtual object from the computer device 102c. Each virtual object participating in the game has its own game data, this part of the data may be recorded as original game data, that is, the original game data of any virtual object refers to game data owned by the virtual object itself. The original game data includes an original game skill, an original object image, an original associated data, and the like of a corresponding virtual object. The original associated data refers to related parameters of the virtual object in the game, for example, an original summoned object, an original skill effect, an original attribute value, and original gain information, which is not limited herein. In other words, in this disclosure, “original” is configured for being owned by the virtual object itself.

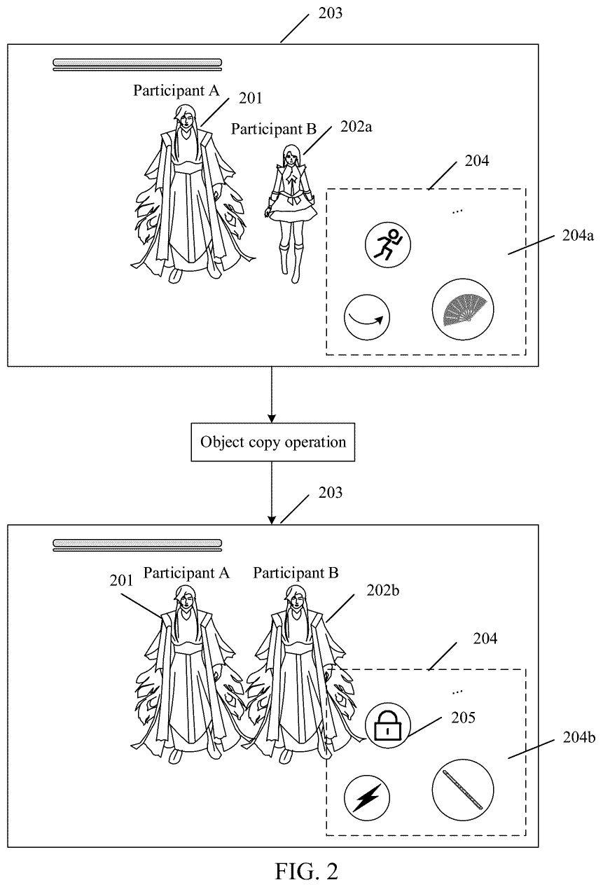

In some embodiments, referring to FIG. 2, FIG. 2 is a schematic diagram of a game processing scenario according to an embodiment of this disclosure. As shown in FIG. 2, a computer device responds to an object copy operation on a first virtual object 201, and displays a first game skill icon 204b in a skill display region 204 of a game interface 203 in which a second virtual object is located. In some embodiments, in the game interface 203, the second virtual object is displayed as an object image 202a. The object image 202a may be an original object image of the second virtual object, or may be a copy object image of the second virtual object. The original object image refers to an object image owned by the second virtual object itself, and the copy object image refers to an object image of another virtual object copied when the second virtual object is in a copy state. That is, if the second virtual object is in an original state, the object image 202a is the original object image of the second virtual object; and if the second virtual object is in a copy state, the object image 202a is the copy object image of the second virtual object. In the skill display region 204 of the game interface 203, a game skill 204a of the second virtual object is displayed. If the second virtual object is in the original state, the game skill 204a is an original game skill of the second virtual object; and if the second virtual object is in the copy state, the game skill 204a is a copy game skill of the second virtual object.

In some embodiments, in response to the object copy operation on the first virtual object 201, the first game skill icon 204b is displayed in the skill display region 204 of the game interface 203 in which the second virtual object is located, where the first game skill icon refers to an icon of a first game skill associated with the first virtual object. The object image of the second virtual object is switched to a first object image 202b for display, where the first object image refers to an object image of the first virtual object. In this case, the first virtual object and the second virtual object are displayed with the same object image. When responding to the object copy operation on the first virtual object, if the first virtual object is in an original state, a game skill associated with the first virtual object is an original game skill of the first virtual object, and the object image of the first virtual object is an original object image of the first virtual object; and if the first virtual object is in a copy state, the game skill associated with the first virtual object is a copy game skill of the first virtual object, and the object image of the first virtual object is a copy object image of the first virtual object. In other words, the object copy function implemented in this embodiment of this disclosure may be transitive, that is, if a copy target (that is, the first virtual object) of a player who initiates copying (that is, the second virtual object controlled by the player) is already in a state of copying another player (that is, the copy state), the another player needs to be used as a template for copying. For example, a virtual object A copies a virtual object B. In this case, if a virtual object C chooses to copy the virtual object A, a copy result of the virtual object C is equivalent to that the virtual object C copies the virtual object B, achieving a game data transmission effect of “the virtual object B->the virtual object A->the virtual object C”, which may improve the diversity and content richness of the game, and improve the interest of the game to a certain extent.

In some embodiments, as shown in FIG. 2, an object name of each virtual object may be displayed in association with the virtual object. For example, assuming that an object name of the first virtual object 201 is “participant A” and an object name of the second virtual object is “participant B”, before and after the second virtual object is updated for display, the object name displayed in association with the second virtual object does not change, which is “participant B” herein all the time. In some embodiments, a quantity of the first game skill icons is one or at least two. As shown in FIG. 2, when responding to a trigger operation on a first game skill icon 205, the second virtual object is controlled to cast a first game skill indicated by the first game skill icon 205. Similarly, when responding to a trigger operation on any first game skill icon, the second virtual object is controlled to cast a first game skill indicated by the first game skill icon. In other words, when the second virtual object copies another virtual object, a game skill of the another virtual object may be used after the copying is completed.

It may be understood that the computer device mentioned in this embodiment of this disclosure includes, but is not limited to, a terminal device or a server. In other words, the computer device may be a server or a terminal device, or may be a system including a server and a terminal device. The terminal device mentioned above may be a computer device, including, but not limited to, a mobile phone (a computer device 102c as shown in FIG. 1), a tablet computer, a desktop computer, a notebook computer (a computer device 102b as shown in FIG. 1), a palmtop computer, an in-vehicle device (a computer device 102a as shown in FIG. 1), an augmented reality/virtual reality (AR/VR) device, a helmet-mounted display, a wearable device, a smart speaker, a digital camera, a camera, and another mobile internet device (MID) having a network access capability. As shown in FIG. 1, the in-vehicle device may be a device integrated in a vehicle 103. The server mentioned above may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a vehicle-road collaboration, a content delivery network (CDN), big data, and an artificial intelligence platform.

In some embodiments, data involved in the embodiments of this disclosure may be stored in a computer device, or data may be stored based on a cloud storage technology or a blockchain network. This is not limited herein.

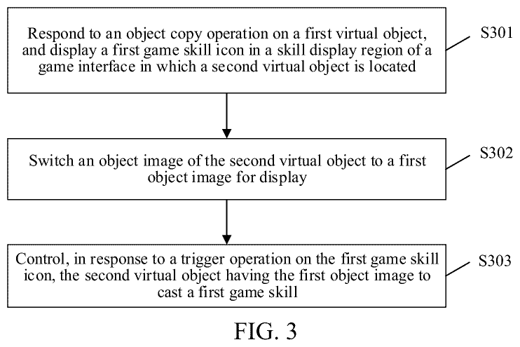

FIG. 3 is a flowchart of a game processing method according to an embodiment of this disclosure. As shown in FIG. 3, the game processing process includes the following steps:

Step S301: Respond to an object copy operation on a first virtual object, and display a first game skill icon in a skill display region of a game interface in which a second virtual object is located. In an example, a first game skill control element is displayed in a control region of the second virtual object in a game interface based on a request from a user of a second virtual object to perform an object copy function on a first virtual object. The first game skill control element being associated with a first game skill of the first virtual object.

In the embodiments of this disclosure, the computer device may display the first game skill icon in the skill display region of the game interface in which the second virtual object is located in response to the object copy operation on the first virtual object, where the object copy operation is triggered by a player controlling the second virtual object, and the first game skill icon refers to an icon of the first game skill associated with the first virtual object.

In some embodiments, the computer device may trigger the object copy operation on the first virtual object in response to the trigger operation on the object copy function, and display the first game skill icon in the skill display region of the game interface in which the second virtual object is located. The object copy function may be directly assigned to the second virtual object, or may be assigned to the second virtual object when the second virtual object satisfies a function obtaining condition. This is not limited herein.

When responding to the object copy operation on the first virtual object, if the first virtual object is in the original state, an icon of the first game skill associated with the first virtual object is an icon of the original game skill of the first virtual object, and the object image of the first virtual object is the original object image of the first virtual object; or if the first virtual object is in the copy state, an icon of the first game skill associated with the first virtual object is an icon of the copy game skill of the first virtual object, and the object image of the first virtual object is the copy object image of the first virtual object. In other words, the object copy function implemented in the embodiments of this disclosure may be transitive, that is, if a player who initiates a copy (that is, a player who controls the second virtual object), and a copy target (that is, the first virtual object) of the player is already in a state of copying another virtual object (that is, the copy state), the another player should be used as a template for copying. For example, a player who controls the virtual object A copies the virtual object B. In this case, if the virtual object C chooses to copy the virtual object A, a copy result of the virtual object C is equivalent to the virtual object C copying the virtual object B, achieving a game data transmission effect of “the virtual object B->the virtual object A->the virtual object C”, which may improve diversity and content richness of the game, and improve interest of the game to a certain extent.

For example, the computer device may display the function obtaining condition in response to an obtain operation on the object copy function. When the second virtual object satisfies the function obtaining condition, the object copy function is associated with the second virtual object, and the object copy function is configured for triggering the object copy operation.

The function obtaining condition may be determined by a game scene configuration or a game boss mechanism. For example, the computer device may associate the object copy function with the second virtual object in a target type scene in response to an entry operation on the target object scenario. The target type scene refers to a game scene that can provide a player with the object copy function. Alternatively, the computer device may enter a target object scene in response to an entry operation on the target object scene. When the target type scene reaches a target game stage, the object copy function is associated with the second virtual object, that is, when a certain game stage is reached (that is, the target game stage), the player is provided with the object copy function. This is not limited herein.

In some embodiments, when the second virtual object has the object copy function, the computer device may display the object copy function. The object copy function is configured for changing one virtual object into another virtual object and completely copying game data of the another virtual object, including the object image (for example, clothing, face shaping data, body shape, and gender) and associated data (for example, a game skill, a routine, an attribute value/a game character combat resource, and a game character interaction panel).

In some embodiments, the object copy operation on the first virtual object may include a trigger operation on the object copy function, and a select operation on the first virtual object. The computer device may display a candidate virtual object in response to the trigger operation on the object copy function, and the candidate virtual object is determined based on the object copy function. For example, if the object copy function does not limit the copy object, the candidate virtual object may be all virtual objects in the game scene in which the second virtual object is located. Alternatively, the candidate virtual object may refer to a virtual object in a same game camp as the second virtual object, that is, the object copy function requires copying a virtual object in the same game camp. In response to the select operation on the first virtual object in the candidate virtual objects, the first game skill icon is displayed in the skill display region of the game interface in which the second virtual object is located.

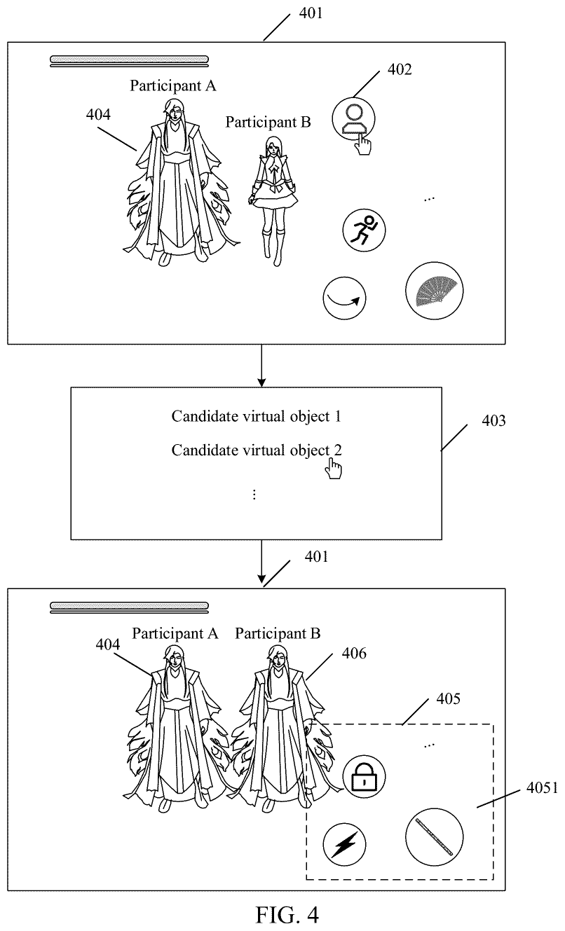

For example, FIG. 4 is a schematic diagram of an object copy scenario according to an embodiment of this disclosure. As shown in FIG. 4, a computer device may display an object copy function 402 in a game interface 401 in which a second virtual object (participant B) is located, and display a candidate virtual object 403 in response to a trigger operation on the object copy function 402, where a quantity of the candidate virtual objects 403 is one or at least two, such as a candidate virtual object 1 and a candidate virtual object 2 shown in FIG. 4; and display, in response to a select operation on a first virtual object 404 (assumed as the candidate virtual object 2) in the candidate virtual objects 403, a first game skill icon 4051 in a skill display region 405 of the game interface 401 in which the second virtual object is located.

Alternatively, the object copy operation on the first virtual object includes a trigger operation on the first virtual object and a trigger operation on the object copy function. The computer device may display, in response to the trigger operation on the first virtual object, candidate functions associated with the first virtual object, where the candidate function refers to a function of the second virtual object for a trigger permission of the first virtual object; and display, in response to the trigger operation on the object copy function in the candidate functions, the first game skill icon in the skill display region of the game interface in which the second virtual object is located.

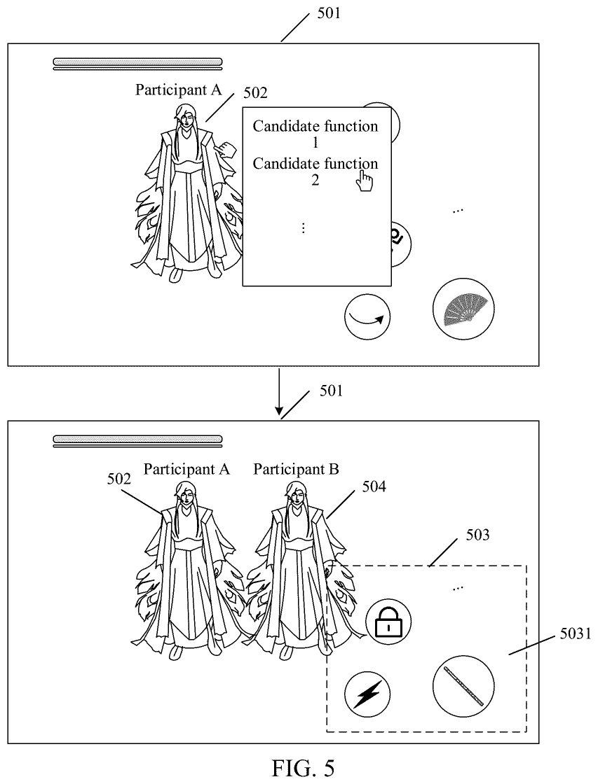

For example, FIG. 5 is a schematic diagram of another object copy scenario according to an embodiment of this disclosure. As shown in FIG. 5, a computer device may display a first virtual object 502 (participant A) in a game interface 501 in which a second virtual object is located, display, in response to a trigger operation on the first virtual object 502, candidate functions associated with the first virtual object 502, where the candidate functions may include, but are not limited to, a candidate function 1 and an object copy function (that is, a candidate function 2); and display, in response to a trigger operation on the object copy function in the candidate functions, a first game skill icon 5031 in a skill display region 503 of the game interface 501 in which the second virtual object is located. There may be a large quantity of functions in a game, there are also a plurality of functions for interaction between different virtual objects, and functions that can be triggered between the same virtual object and different virtual objects may be different. For example, assuming that the second virtual object may trigger an object copy function, a player killing (PK) function, and an action interaction function for the first virtual object, it represents that the second virtual object has a permission of triggering the object copy function, the player killing (PK) function, and the action interaction function for the first virtual object. That is, the foregoing candidate function may include the object copy function, the player killing (PK) function, and the action interaction function. There may further be a position synchronization invitation function between different virtual objects. Assuming that the second virtual object cannot trigger the position synchronization invitation function for the first virtual object, it represents that the second virtual object does not have a permission of triggering the position synchronization invitation function for the first virtual object, that is, the foregoing candidate function does not include the position synchronization invitation function.

Alternatively, the object copy operation on the first virtual object may include a slide operation from the first virtual object to the object copy function, and the computer device may respond to the slide operation from the first virtual object to the object copy function, and display the first game skill icon in the skill display region of the game interface in which the second virtual object is located. In this manner, the player may directly slide from a virtual object that the player intends to copy (that is, the first virtual object) to the object copy function to trigger the object copy function for the first virtual object. The operation is simple and fast, especially in a game battle, which may easily implement copying between virtual objects and save a trigger time of the object copy function. In addition, due to the time continuity of the game battle, that is, pausing cannot be performed, triggering the object copy function in this manner can effectively save a morphing time, reduce the time for triggering the object copy function, and improve the game interaction efficiency.

Alternatively, the object copy operation on the first virtual object may include a trigger operation on a first skill shortcut key corresponding to the object copy function, and the computer device may respond to the trigger operation on the first skill shortcut key corresponding to the object copy function, and display the first game skill icon in the skill display region of the game interface in which the second virtual object is located. For example, assuming that the first skill shortcut key corresponding to the object copy function is “ctrl+qx”, and x is configured for representing a virtual object to which the object copy function is targeted. Generally, in a game battle, the computer device displays each virtual object participating in the game battle, and x may be a sequence number of each virtual object. For example, in “a virtual object 1, a virtual object 2, and a virtual object 3”, 2 may be configured for indicating the virtual object 2. Alternatively, x may indicate an object type, for example, 1 is configured for indicating a healing character type, 2 is configured for indicating a carry character type, and 3 is configured for indicating a tank character type. Then, the computer device receives a trigger operation on the skill shortcut key “ctrl+qx”, determines a virtual object indicated by x (which is the first virtual object herein), and triggers the object copy function for the first virtual object. For example, assuming that x is configured for indicating an object type, when detecting the trigger operation on the first skill shortcut key “ctrl+q1”, the computer device may determine a virtual object corresponding to the healing character type as the first virtual object, trigger the object copy operation on the first virtual object, and display the first game skill icon in the skill display region of the game interface in which the second virtual object is located.

Alternatively, the object copy operation on the first virtual object may include a trigger operation on a second skill shortcut key corresponding to the object copy function and a trigger operation on a third skill shortcut key, where the trigger operation on the third skill shortcut key is configured for triggering the object copy function for a virtual object indicated by the third skill shortcut key. In some embodiments, the computer device may display candidate virtual objects in response to the trigger operation on the second skill shortcut key corresponding to the object copy function; and determine, in response to the trigger operation on the third skill shortcut key, a candidate virtual object indicated by the third skill shortcut key in the candidate virtual objects as the first virtual object. For example, assuming that the third skill shortcut key is “ctrl+qy”, and y is configured for representing the candidate virtual object indicated by the third skill shortcut key. Generally, y may be a sequence number of each candidate virtual object, for example, in “a candidate virtual object 1, a candidate virtual object 2, and a candidate virtual object 3”, 2 may be configured for indicating the candidate virtual object 2. The first virtual object is determined based on the third skill shortcut key, and the object copy function is triggered for the first virtual object. For example, assuming that the second skill shortcut key is “ctrl+q”, when detecting the trigger operation on the second skill shortcut key “ctrl+q”, the computer device displays the candidate virtual objects; and determines, in response to the trigger operation on the third skill shortcut key “2”, the second candidate virtual object (the candidate virtual object 2) in the candidate virtual objects as the first virtual object, and triggers the object copy function for the first virtual object.

Triggering the object copy function through the foregoing skill shortcut keys can effectively improve an interaction rate between the player and the game, thereby improving the game interaction efficiency.

The above are only examples of several possible manners for triggering the object copy function, and another manner may also be used for triggering the object copy function. For example, FIG. 4 is used as an example, the object copy operation on the first virtual object may include a select operation on the first virtual object and a trigger operation on the object copy function. The computer device may display the first game skill icon 4051 in the skill display region 405 of the game interface in which the second virtual object is located in response to the select operation on the first virtual object 404 and the trigger operation on the object copy function 402, where the select operation on the first virtual object 404 is configured for setting the first virtual object 404 to a selected state, and when the first virtual object 404 is in the selected state, the trigger operation on the object copy function 402 is received. In this case, the selected state is configured for indicating that the trigger operation on the object copy function is for the first virtual object 404.

Step S302: Switch an object image of the second virtual object to a first object image for display. In an example, a display of the second virtual object in the game interface is switched from a second object image of the second virtual object to a first object image of the first virtual object based on the request.

In this embodiment of this disclosure, the computer device may switch the object image of the second virtual object to the first object image for display, where the first object image refers to an object image of the first virtual object. If the first virtual object is in an original state, the object image of the first virtual object is an original object image the first virtual object, and in this case, the first object image refers to the original object image of the first virtual object; and if the first virtual object is in a copy state, the object image of the first virtual object is a copy object image of the first virtual object, and in this case, the first object image refers to the copy object image of the first virtual object. The first object image may be considered as a copy object image of the second virtual object. In other words, in this case, the object image of the second virtual object is the same as the object image of the first virtual object.

As shown in FIG. 4, in the game interface 401, the object image of the second virtual object (participant B) is switched to a first object image 406 for display. Alternatively, as shown in FIG. 5, in the game interface 501, the object image of the second virtual object (participant B) is switched to a first object image 504 for display.

In some embodiments, an execution sequence of the process of displaying a first game skill icon in a skill display region of a game interface in which a second virtual object is located in step S301 and step S302 is not limited to the foregoing sequence, and may alternatively be executed synchronously. Alternatively, the execution sequence may be that the object image of the second virtual object is switched to the first object image for display in response to the object copy operation on the first virtual object, and the first game skill icon is displayed in the skill display region of the game interface in which the second virtual object is located. This is not limited herein.

In some embodiments, the computer device may switch a display state of the object copy function to a cool down state, and display a remaining cool down (CD) time of the object copy function in association with the object copy function. When the remaining cool down time is a cool down end time, the display state of the object copy function is switched to a working state.

In an example, the object copy function in the working state is displayed, and the display state of the object copy function is switched from the working state to the cool down state in response to the trigger operation on the object copy function. When the object copy function is in the cool down state, the object copy function cannot respond to the trigger operation on the object copy function. When the cool down ends (that is, the remaining cool down time is the cool down end time), the display state of the object copy function is switched to the working state, and then the object copy function is provided again. That is, when the display state is in the working state, the object copy function can respond to the trigger operation on the object copy function.

In some embodiments, the foregoing working state is configured for indicating a display state in which the object copy function can respond to the trigger operation on the object copy function, and the foregoing cool down state is configured for indicating a display state in which the object copy function cannot respond to the trigger operation on the object copy function.

To trigger the object copy function, game data of one virtual object needs to be fully updated to game data of another virtual object, original game data of the virtual object performing morphing needs to be retained, and other virtual objects in the same game scene also need to synchronize game data of a morphed virtual object performing morphing in time, that is, implementation of the object copy function is not just a simple update of one virtual object. Therefore, a cool down time may be added for the object copy function. When the cool down ends (that is, the remaining cool down time is the cool down end time), the object copy function is provided again, so that different virtual objects may synchronize data update caused by the object copy function in time, which reduces game data disorder caused by continuous morphing, ensures normal operation of the game, and improves function experience and function operation effects of the object copy function.

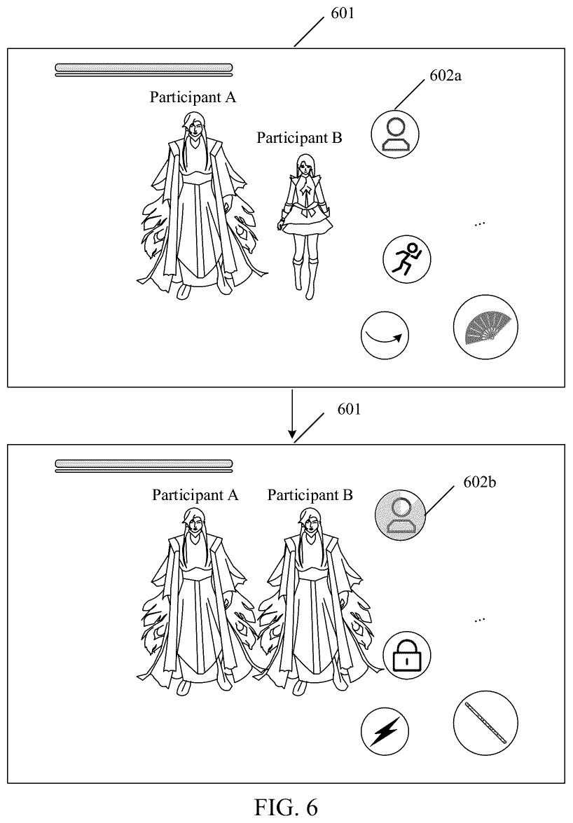

FIG. 6 is a schematic diagram of a display scenario of an object copy function according to an embodiment of this disclosure. As shown in FIG. 6, in a possible display condition, an object copy function 602a in a working state (or available state) is displayed in a game interface 601 in which the second virtual object is located. The working state is configured for indicating that the object copy function 602a may be triggered. After the foregoing step S301 and step S302 are performed, a display state of the object copy function is switched to a cool down state (or unavailable state). That is, in the game interface 601, the object copy function 602a in the working state is switched to an object copy function 602b in the cool down state, where the object copy function 602b in the cool down state cannot be triggered. In a possible display mode as shown in FIG. 6, a grayscale mask may be added to the object copy function 602a in the working state, and the object copy function 602a is set to be unavailable, that is, the cool down state, to obtain the object copy function 602b. The mask may be considered as a plate covered on the object copy function, and the grayscale may be considered as transparency. Adding a grayscale mask to the object copy function 602a is equivalent to adding a non-completely transparent layer independent of the object copy function 602a to the object copy function 602a to indicate that the obtained object copy function 602b is in a cool down state. The grayscale mask does not affect the original object copy function, which is equivalent to causing the object copy function to be unavailable, and the grayscale mask provides a certain protection effect to the object copy function, so that whether the object copy function is available may be learned more intuitively, thereby improving a game display effect. In some embodiments, a remaining cool down time of the object copy function 602b may be obtained, a coverage area is determined based on the remaining cool down time, and the grayscale mask in the object copy function 602b is updated based on the coverage area, so that the coverage area of the grayscale mask in the object copy function 602b may be configured for representing the remaining cool down time of the object copy function 602b.

In some embodiments, the remaining cool down time of the object copy function 602b may be directly displayed in association with the object copy function 602b. When the remaining cool down time is a cool down end time, the display state of the object copy function is switched to the working state, that is, the object copy function 602b is switched to the object copy function 602a for display. In this case, the object copy function 602a may be triggered. Certainly, FIG. 6 is only a display mode of an object copy function in a possible working state.

Step S303: Control, in response to a trigger operation on the first game skill icon, the second virtual object having the first object image to cast a first game skill. In an example, the second virtual object is controlled to perform the first game skill based on a user interaction with the first game skill control element in the control region of the second virtual object in the game interface.

In the embodiments of this disclosure, a quantity of the first game skill icons is one or at least two, each first game skill icon corresponds to one first game skill, and the first game skill may be triggered by the second virtual object. In some embodiments, in response to the trigger operation on the first game skill icon, the second virtual object may be controlled to cast the first game skill indicated by the first game skill icon, so that the second virtual object may morph into another virtual object and use a game skill of the another virtual object. In this way, in a game battle, the foregoing object copy function may be used to copy virtual objects of different object types, so that when there is a quantity limit in the game battle, requirements for the virtual objects of different object types may also be satisfied.

In addition, when no game battle needs to be performed, the second virtual object may also morph into the first virtual object through the foregoing process, to experience the game skill of the first virtual object, or experience the object image of the first virtual object, thereby improving the content richness and interest of the game. In addition, each virtual object may further interact with another virtual object through the foregoing process, thereby improving the interactivity of the game.

In some embodiments, the computer device may switch, in response to a switch operation on a target game character, a game skill icon displayed in the skill display region of the game interface in which the second virtual object is located to a second game skill icon for display, where the second game skill icon refers to an icon of a game skill of the target game character.

The target game character refers to any game character, that is, any game character into which the second virtual object intends to morph. The object image of the second virtual object is switched to a target object image corresponding to the target game character for display. In other words, game character transformation may be directly performed, that is, the player may directly select a game character into which the player intends to morph without selecting another virtual object, and directly implement game character transformation. The second virtual object is controlled, in response to a trigger operation on the second game skill icon, to cast the game skill of the target game character indicated by the second game skill icon, so that character style or skill transformation is implemented, thereby improving the playability and interest of the game. The game character refers to a type category of characters in a game, and is configured for representing a job that the game character takes on in the game. Game characters included in different games may be different. For example, the game characters in some games may include, but are not limited to, a doctor character, a tank characters, a magic damage character, and a physical damage character. The game characters in some other games may include, but are not limited to, a critical damage carry character, an internal injury carry character, a tank character, a healer character, and a control character.

In some embodiments, the computer device may cancel display of a game skill icon displayed in the skill display region in response to a morph operation on a target game item; and switch the object image of the second virtual object to an item image of the target game item for display, and display a target game skill icon associated with the morph operation. In response to a trigger operation on the target game skill icon associated with the morph operation, the second virtual object is controlled to cast a target game skill indicated by the target game skill icon.

The target game item may refer to a scene item, such as a flower, a tree, a table, a chair, or an ornament. Alternatively, the computer device starts a target game scene, and displays a target game skill icon. The target game skill icon may include a morph function icon, a moving icon, a direction changing icon, and the like, and in response to a morph operation on a target game item, the object image of the second virtual object is switched to an item image of the target game item for display. By switching the object image of the second virtual object to the item image of the target game item for display, the virtual object may morph into a scene item and merge into the target game scene, and a hide-and-seek mini-game may be implemented. By adding such mini-games to the game, the content richness and diversity of the game are improved, and the interest of the game is increased.

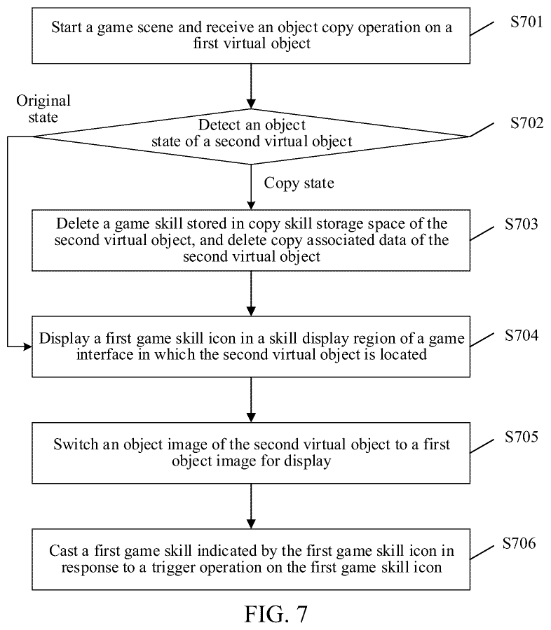

FIG. 7 is a schematic diagram of a specific procedure of game processing according to an embodiment of this disclosure. As shown in FIG. 7, a game processing process includes the following steps:

Step S701: Start a game scene and receive an object copy operation on a first virtual object.

In the embodiments of this disclosure, the computer device may start the game scene, and receive the object copy operation on the first virtual object in the game scene.

In some embodiments, after starting the game scene, the computer device may perform object copy prompt based on the game scene.

In some embodiments, for example, in a first game scene, the computer device may display the first game scene in response to a startup operation on the first game scene, and display a third virtual object in the first game scene, where the third virtual object refers to a virtual object in a different game camp from the second virtual object. In other words, the third virtual object and the second virtual object are enemies. For example, the third virtual object may be a game boss (boss) or an enemy player.

In some embodiments, a copy object type reminder message for the third virtual object is displayed in the first game scene, where an object type of the first virtual object is a copy object type indicated by the copy object type reminder message.

In some embodiments, the computer device may obtain attack information of the third virtual object, determine a copy object type for the third virtual object based on the attack information, and display a copy object type reminder message for the third virtual object based on the copy object type. The object type of the virtual object is configured for representing a game character of the virtual object. The object types may include, but are not limited to, a tank character type, a healing character type, a carry character type, a control character type, and the like. Different character types may further include a smaller character type division.

In some embodiments, the determining a copy object type for the third virtual object based on the attack information may be implemented in the following manners: obtaining a target mapping relationship, where the target mapping relationship includes a plurality of index entries of attack information-copy object type, querying a target index entry including attack information of the third virtual object from the target mapping relationship, and determining the copy object type in the target index entry as the copy object type for the third virtual object.

In some embodiments, the foregoing virtual object of the copy object type for the third virtual object is configured for responding to an attack indicated by the attack information of the third virtual object, and the copy object type reminder message is configured for prompting the second virtual object to trigger an object copy operation on the virtual object of the copy object type. Since the object type of the first virtual object is the copy object type indicated by the copy object type reminder message, the copy object type reminder message is configured for prompting the second virtual object to trigger an object copy operation on the first virtual object.

For example, assuming that the attack information of the third virtual object is obtained, indicating that the attack of the third virtual object reduces a first energy parameter (for example, soul power) of the second virtual object, when a value of the first energy parameter is zero, the second virtual object is defeated. In some embodiments, the second virtual object uses the object copy function to reduce the value of the first energy parameter. Therefore, a player needs to dodge a skill in a regular stage, limits a copy capability, and increases injury bearing of the virtual object. In other words, the player needs to avoid the skill as much as possible and not abuse the object copy function. However, when a quantity of injuries bore by a virtual object of the tank character type reaches an upper limit, an identity of the virtual object of the tank character type needs to be exchanged with another virtual object of the non-tank character type, so that another virtual object may morph into a virtual object of the tank character type, and continue to bear injuries, thereby coping with the attack of the third virtual object. Therefore, the copy object type (the tank character type herein) for the third virtual object may be determined based on the attack information of the third virtual object, and the copy object type reminder message is displayed based on the copy object type, for example, “it is recommended to add a tank character type player”.

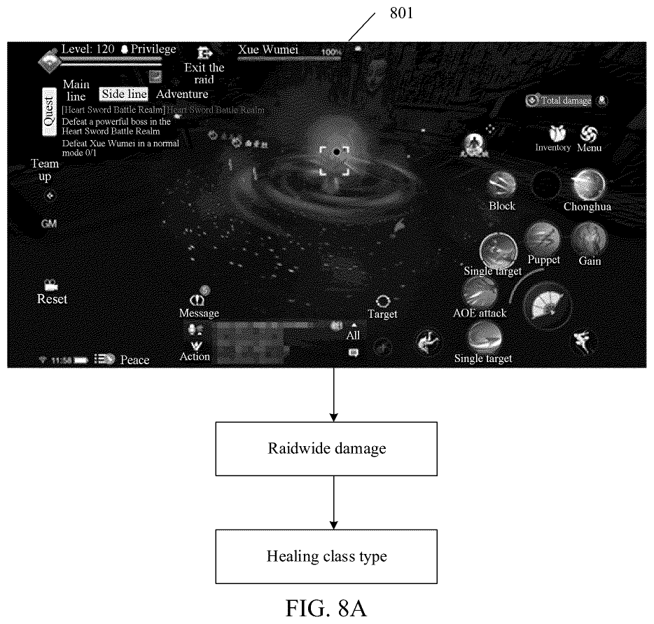

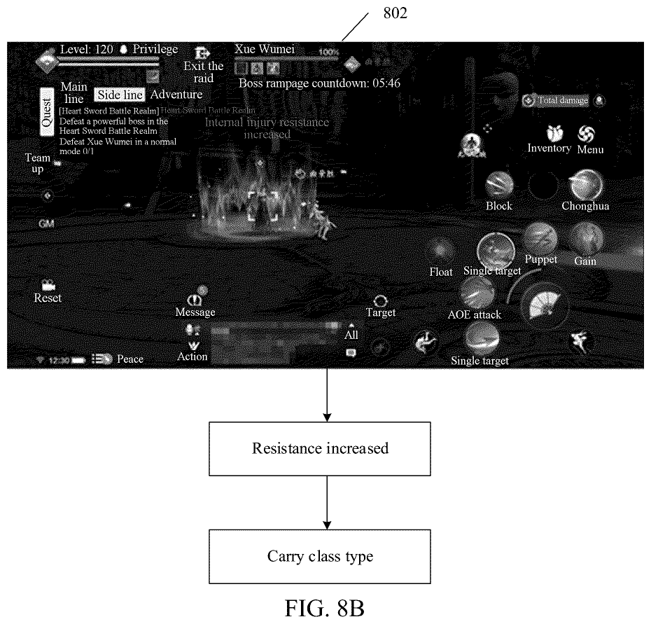

For example, FIG. 8A is a schematic diagram of an object copy reminder scenario according to an embodiment of this disclosure. As shown in FIG. 8A, assuming that attack information 801 of the third virtual object is obtained, the attack information 801 is configured for indicating that the third virtual object causes a long-time damage over time to raidwide virtual objects, that is, a group damage over time, to cause damage to health points of all the raidwide virtual objects, which is raidwide damage. The copy object type for the third virtual object is determined based on the attack information 801, and is a healing character type herein. The copy object type reminder message is displayed based on the copy object type, for example, “it is recommended to add a healing character type player”.

For example, FIG. 8B is a schematic diagram of another object copy reminder scenario according to an embodiment of this disclosure. As shown in FIG. 8B, assuming that attack information 802 of the third virtual object is obtained, the attack information 802 is configured for indicating that the third virtual object periodically switches a resistance type (for example, a critical damage type/an internal injury type) of the third virtual object, that is, indicating that the resistance is increased. The copy object type for the third virtual object is determined based on the attack information 802, and is a carry character type herein. The carry character type may include N carry character types, and each carry character type is configured for corresponding to a resistance type. For example, assuming that there are two resistance types, a critical damage type and an internal injury type, it may be considered that a first carry character type (that is, a critical damage carry character type) and a second carry character type (that is, an internal injury carry character type) are included. If a resistance type of the third virtual object is an i^{th} resistance type, it is determined that the copy object type is a carry character type other than a carry character type corresponding to the i^{th} resistance type. For example, if the resistance type of the third virtual object is the critical damage type, it may be determined that the copy object type is the internal injury carry character type; and if the resistance type of the third virtual object is the internal injury type, it may be determined that the copy object type is the critical damage carry character type. The copy object type reminder message is displayed based on the copy object type, for example, “it is recommended to add a XX carry character type player”.

In some embodiments, the third virtual object may have a plurality of pieces of attack information. For different attack information of the third virtual object, a corresponding copy object type reminder message is displayed. The attack information may be in a one-to-one correspondence with the copy object type reminder message. The copy object type reminder message is configured for prompting the second virtual object to trigger an object copy operation on a virtual object of the copy object type, so that the second virtual object can cope with attack damage caused by the corresponding attack information of the third virtual object.

In this way, since the copy object type reminder message is configured for prompting the second virtual object to trigger an object copy operation on the first virtual object, the object type of the first virtual object is the copy object type indicated by the copy object type reminder message, so that the second virtual object is reminded to switch to the virtual object of the copy object type indicated by the copy object type reminder message through the copy object type reminder message, to cope with the attack damage caused by the corresponding attack information of the third virtual object, which effectively improves the game skill of the second virtual object, implements a balance between different object types in a game battle, satisfies requirements for players of various object types in the game battle, and improves the playability and content richness of the game.

In some embodiments, a second game scene is used as an example. The computer device may display, in response to a startup operation on the second game scene, a game stage included in the second game scene and a key object type prompt message for the game stage; and display the second game scene in response to a confirm operation on the second game scene, and during the game stage, respond to the object copy operation on the first virtual object, where an object type of the first virtual object is a key object type indicated by the key object type prompt message for the game stage.

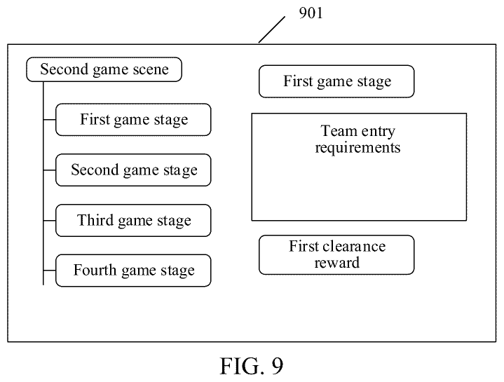

FIG. 9 is a schematic diagram of a game scene prompt according to an embodiment of this disclosure. As shown in FIG. 9, assuming that the second game scene 901 includes a first game stage, a second game stage, a third game stage, and a fourth game stage, the computer device may display, in response to a view operation on any game stage, game stage information of the game stage, for example, a team entry requirement, combat effectiveness information, a first-time clearance reward, and an introduction of a game boss of the game stage. Different game stages have different object type requirements for the virtual object participating in the game. Based on the object type requirements of different game stages, the key object type prompt message for each game stage may be displayed.

In some embodiments, the computer device may display the function obtaining condition in response to an obtain operation on the object copy function. When the second virtual object satisfies the function obtaining condition, the object copy function is associated with the second virtual object, and the object copy function is configured for triggering the object copy operation. Specifically, reference may be made to a related description of step S301 shown in FIG. 3.

FIG. 9 is used as an example. Assuming that the first game stage to the third game stage are ghosts of the game boss of the second game scene, that is, self-copy, the game scene configuration is configured for representing reaching the fourth game stage and obtaining the object copy function. In this case, the function obtaining condition is to enter the fourth game stage. When the second virtual object enters the fourth game stage, it represents that the second virtual object satisfies the function obtaining condition and the second virtual object is associated with the object copy function. For example, if the game scene configuration of a certain game scene is automatically obtained upon entering the game scene, the computer device detects that the second virtual object enters the game scene, and the second virtual object is associated with the object copy function. The function obtaining condition may be updated based on needs.

In some embodiments, the computer device receives the object copy operation on the first virtual object, and performs step S702.

Step S702: Detect an object state of the second virtual object.

In the embodiments of this disclosure, the computer device may detect the object state of the second virtual object. If the second virtual object is in a copy state, step S703 is performed; or if the second virtual object is in an original state, step S704 is performed. The original state is configured for representing that the second virtual object is not morphing, and the copy state is configured for representing that the second virtual object is morphing into another virtual object.

Step S703: Delete a game skill stored in copy skill storage space of the second virtual object, and delete copy associated data of the second virtual object.

In the embodiments of this disclosure, the computer device may delete the game skill stored in the copy skill storage space of the second virtual object, and delete the copy associated data of the second virtual object. The copy associated data of the second virtual object refers to related parameters of the virtual object copied by the second virtual object in the game, including, but not limited to, a copied summoned object, a copied skill effect, a copied attribute value, copied gain information, and the like. This is not limited herein. In some embodiments, the computer device may reclaim a copied summoned object of the second virtual object, delete the game skill stored in the copy skill storage space, that is, give up all game skills learned through morphing (that is, object copying); delete a copy skill effect stored in copy effect storage space, store a skill effect corresponding to the first game skill in the copy effect storage space; obtain a second attribute value of the first virtual object, update object attribute information of the second virtual object based on the second attribute value; and delete copy gain information generated by the second virtual object in the copy state, and add target gain information to the second virtual object based on the object type of the first virtual object, where the target gain information refers to gain information corresponding to the object type of the first virtual object. Reference may be made to a related process of updating the gain information in step S704. In some embodiments, the first game skill is stored to the copy skill storage space, the first game skill is read from the copy skill storage space associated with the second virtual object, and the first game skill icon of the first game skill is displayed in the skill display region of the game interface in which the second virtual object is located. For this process, reference may be made to a related process of updating the first game skill in step S704. Step S705 is performed. In other words, a morphing process of the second virtual object may include “cancel the morphing process” and “the morphing process”.

In some embodiments, the computer device may receive a morphing cancel notification transmitted by the server, and update game data of the second virtual object to original game data based on the morphing cancel notification. The computer device may reclaim the copied summoned object of the second virtual object, delete the game skill stored in the copy skill storage space, that is, give up all game skills learned through morphing (that is, object copying), delete a shielding mark of the original game skill, and restore the game skill of the second virtual object. The computer device may delete the copy skill effect stored in the copy effect storage space, and add the original skill effect of the second virtual object to the second virtual object. The computer device may obtain the original attribute value of the second virtual object from the copy attribute storage space, and update the object attribute information of the second virtual object based on the original attribute value. The computer device may delete the copy gain information generated by the second virtual object in the copy state, and add the original gain information of the second virtual object to the second virtual object. To implement restoring of the game data of the second virtual object, this process may also be implemented by the server. The server implements restoring of the game data of the second virtual object by performing the foregoing steps, and transmits a full data packet of the second virtual object after the game data is restored to the computer device. The computer device updates the second virtual object based on the full data packet. Step S704 is performed.

Step S704: Display the first game skill icon in the skill display region of the game interface in which the second virtual object is located.

In the embodiments of this disclosure, in one case, the computer device may display a first energy parameter of the second virtual object in association with the second virtual object. When the first energy parameter is less than or equal to a first energy threshold, an energy abnormality prompt message is displayed. When the first energy parameter is less than or equal to the first energy threshold, it represents that the second virtual object is about to be defeated and is relatively dangerous.

In some embodiments, if the first energy parameter is less than a second energy threshold, an object copy failure message is displayed; or if the first energy parameter is greater than or equal to a second energy threshold, a reset first energy parameter is displayed, and a process of displaying a first game skill icon in a skill display region of a game interface in which a second virtual object is located is performed.

The execution of the object copy function needs to consume the first energy parameter. If the first energy parameter is less than the second energy threshold (that is, the first energy parameter required to execute the object copy function), it represents that the second virtual object does not have enough first energy parameters to support the execution of the object copy function. Therefore, the object copy failure message may be displayed.

In some embodiments, the second energy threshold is configured for indicating whether the first energy parameter of the second virtual object can support execution of the object copy function, and the first energy threshold is configured for indicating whether the second virtual object is about to be defeated. The first energy threshold may be greater than the second energy threshold, the first energy threshold may be equal to the second energy threshold, or the first energy threshold may be less than the second energy threshold.

In an example, when the first energy parameter of the second virtual object continues to decay during the game, and when the first energy threshold is greater than the second energy threshold, the energy abnormality prompt message is first displayed, and then the object copy failure message is displayed during the decay. In this case, it can effectively remind the second virtual object to execute the object copy function in time before the object copy fails, which effectively improves game ability for the second virtual object, and effectively improves playability and content richness of the game.

In an example, when the first energy parameter of the second virtual object continues to decay during the game, and when the first energy threshold is less than the second energy threshold, the object copy failure message is first displayed, and then the energy abnormality prompt message is displayed during the decay. In this case, it can effectively reduce the dependence of the second virtual object on object copying. After the energy abnormality is prompted, a fighting spirit of the second virtual object can be stimulated, and the first energy parameter may stop decaying and show an upward trend, which effectively improves playability and content richness of the game.

The foregoing detection process of the first energy parameter may further be performed in step S701. The computer device receives the object operation on the first virtual object. If the first energy parameter is less than the second energy threshold, the object copy failure message is displayed; or if the first energy parameter is greater than or equal to the second energy threshold, step S702 is performed. Certainly, there are also no restrictions on a morphing frequency and skill avoidance of the virtual object. In other words, when the first energy parameter of the virtual object is cleared, it does not cause the game battle of the virtual object to fail, or the game skill of the virtual object is unable to cast, and the like. The virtual object may freely choose to morphing as needed. In other words, in response to the object copy operation on the first virtual object, the computer device may directly perform step S702 to step S705 to implement the morphing of the second virtual object, and there is no need to detect the first energy parameter of the second virtual object. In other words, the first energy parameter may not be used to limit the morphing of the virtual object. That is, the execution of the object copy function does not need the first energy parameter. As long as the object copy function is not in the cool down state, the object copy function may be trigger.

In some embodiments, the computer device may obtain a camp type of the first virtual object and a camp type of the second virtual object in response to the object copy operation on the first virtual object. If both the camp type of the first virtual object and the camp type of the second virtual object are first camp types, the first game skill icon is displayed in the skill display region of the game interface in which the second virtual object is located. The first camp type may refer to a player character type, and may further include the second camp type, and the second camp type may be a non-player character (NPC) type. In other words, it may be restricted that both parties to the morphing are player character types, that is, in this case, a camp type condition is that both parties to the morphing belong to the first camp type. Certainly, this step is a step in some embodiments, and the camp type of the second virtual object may further be limited to the first camp type. That is, if the camp type of the second virtual object is the first camp type, the first game skill icon is displayed in the skill display region of the game interface in which the second virtual object is located, that is, in this case, the camp type condition is that the virtual object that triggers the morphing belongs to the first camp type.

In some embodiments, the embodiments of this disclosure may further be used to implement artificial intelligence (AI). For example, in a game battle, if a quantity of virtual objects participating in the game battle is relatively small, a virtual object AI may be generated, and the virtual object AI may be used as the second virtual object to perform step S702 to step S706. In other words, no matter whether the camp type of the second virtual object is the first camp type or the second camp type, the object copy function may be triggered, that is, in this case, the camp type condition is that there are no restrictions on the camp type. A process of detecting the camp type of the second virtual object may further be implemented in step S701. When the camp type of the second virtual object satisfies the camp type condition for triggering the object copy function, step S702 is triggered.

In some embodiments, the first game skill icon may be displayed in the skill display region of the game interface in which the second virtual object is located. For this process, reference may be made to a related description in step S301 of FIG. 3. In some embodiments, the computer device may send an object copy request to the server. The server obtains game data of the first virtual object based on the object copy request, generates an object copy response message based on the game data of the first virtual object, and broadcasts the object copy response message to computer devices. The computer device in which the second virtual object is located may update the second virtual object based on the object copy response message, and another computer device may synchronize the morphing of the second virtual object from a perspective of another virtual object based on the object copy response message. The game data of the first virtual object includes the game skill and the associated data of the first virtual object. The object copy response message includes “object copy player: second virtual object, copy object: first virtual object”, the game data of the first virtual object, and the like.

In some embodiments, the computer device may respond to the object copy operation on the first virtual object. If the second virtual object is in an original state, an original summoned object of the second virtual object is reclaimed. If triggered by step S702, the original summoned object of the second virtual object is reclaimed. The computer device may create copy skill storage space for the second virtual object, add a shielding mark to an original game skill of the second virtual object, and store the first game skill in the copy skill storage space, where the first game skill refers to a game skill associated with the first virtual object; and read the first game skill from the copy skill storage space associated with the second virtual object, and display the first game skill icon of the first game skill in the skill display region of the game interface in which the second virtual object is located. The way the server manages game skill learning is to create a memory for managing the game skill on data of the virtual object, which may be referred to as a skill memory. The skill memory stores a game skill and a state of the game skill that a corresponding virtual object has learned. For example, the skill memory of the second virtual object stores the game skill and the state of the game skill that the second virtual object has learned (that is, the original game skill of the second virtual object). When receiving a casting request of the second virtual object for the third game skill, the server checks the original game skill in a skill memory of the second virtual object, and sends related data of the third game skill to the computer device in which the second virtual object is located. The skill memory may further be performed by the computer device in which the second virtual object is located.

The computer device may create copy skill storage space for the second virtual object, and data in the copy skill storage space is not persistently stored in a database to avoid affecting the original game data of the second virtual object. In some embodiments, the shielding mark may be added to the original game skill, and the shielding mark is not stored in the database to avoid causing a problem that the second virtual object cannot cast the game skill normally. The object type of the first virtual object may be obtained, the first game skill corresponding to the second virtual object is determined based on the object type of the first virtual object, and the first game skill is added to the copy skill storage space. This process may further be implemented by the server. The server may learn the first game skill for the second virtual object, and send the first game skill to the computer device in which the second virtual object is located. The computer device in which the second virtual object is located adds the first game skill, and the first game skill may be cast by the second virtual object. In some embodiments, the computer device may obtain the first game skill for the object type of the first virtual object from a skill configuration. The first game skill is equivalent to a copy game skill of the first virtual object.

In some embodiments, the computer device may obtain the object type of the first virtual object, obtain a game skill point possessed by the second virtual object, obtain the first game skill associated with the object type of the first virtual object, allocate the game skill point to the first game skill, and store the first game skill carrying the game skill point to the copy skill storage space.

The game skill point refers to a parameter that can strengthen the game skill. The game skill point possessed by the second virtual object is allocated to the first game skill to strengthen the first game skill possessed by the second virtual object.

In some embodiments, the copy effect storage space may be created for the second virtual object, the skill effect corresponding to the first game skill is obtained, and the skill effect corresponding to the first game skill is stored to the copy effect storage space. To avoid adding/deleting a certain skill effect by mistake when copying/canceling to copy an object, copy effect storage space may be blazed. The copy effect storage space is equivalent to a cache. The skill effect (that is, a skill effect obtained by morphing, which is equivalent to a temporary skill effect) corresponding to the first game skill may be stored in the copy effect storage space, so that an original skill effect of an original game skill of the second virtual object is not affected and security and reliability of game data is ensured. The skill effect is configured for adding an additional effect to the corresponding first game skill. For example, if a first game skill is an attack skill and a skill effect of the first game skill is deceleration, when the first game skill carrying the skill effect is cast, attack damage and a deceleration effect is caused to a virtual object to which the first game skill is targeted.

In some embodiments, after the second virtual object is morphed, a change in object type may cause some of original attributes of the second virtual object to be incompatible with the morphed object type, for example, attributes such as a critical damage/internal injury and sect resources in a game. Therefore, when the second virtual object performs an object copy operation, the attributes of the second virtual object may be adjusted. In some embodiments, copy attribute storage space may be created for the second virtual object, a first attribute value possessed by the second virtual object is obtained, and the first attribute value is stored in the copy attribute storage space. The first attribute value may refer to an attribute value before the morphing of the second virtual object, a maximum attribute value, and the like. A second attribute value corresponding to the object type of the first virtual object is obtained, and object attribute information of the second virtual object is updated based on the second attribute value. Since values of different attributes are generally different under different object types, the attribute of the virtual object is generally assigned the value. Therefore, when the second virtual object performs an object copy operation, the first attribute value before the second virtual object is morphed may be stored, so that when the game data of the second virtual object is restored, an original first attribute may be obtained. In some embodiments, when the game scene in which the second virtual object is located changes, for example, a game map changes or a game battle changes, the object attribute information of the second virtual object may be updated based on the first attribute value to improve the security of the game data and avoid a serious attribute confusion problem.

In some embodiments, gain information associated with the second virtual object may be obtained. The gain information includes first type gain information and second type gain information, a gain duration of the first type gain information is greater than a gain duration of the second type gain information. The first type gain information may be considered as permanent gain information (Buff), and the second type gain information may be considered as temporary gain information. First gain information associated with the object type of the second virtual object is deleted in the second type gain information, and second gain information is reset. The second gain information refer to second type gain information other than the first gain information in the second type gain information.

In other words, for the temporary gain information, gain information related to the object type before the second virtual object morphs may be deleted, and a gain effect of another gain information is reset after the second virtual object morphs. Third gain information may be determined based on the object type of the first virtual object, and the third gain information may be added to the second virtual object. In some embodiments, the first type gain information may be stored. In some embodiments, third gain information may be determined based on the object type of the first virtual object, fourth gain information that does not belong to the third gain information is deleted in the first type gain information, and fifth gain information is added to the second virtual object, where the fifth gain information refers to gain information that belongs to the third gain information and does not belong to the first type gain information.

Through the foregoing process, the original game data of the second virtual object may be stored, and stability of the game data of the second virtual object may be maintained, so that when the game data of the second virtual object itself does not change, the copy effect is only achieved at an experience level of the second virtual object. When the second virtual object exits the copy state, the original game data of the second virtual object may be restored, which ensures the essence of the game data.

Step S705: Switch an object image of the second virtual object to a first object image for display.

In the embodiments of this disclosure, the computer device may switch the object image of the second virtual object to the first object image for display, including clothing, body shape, and the like of the second virtual object.

S706: Control the second virtual object to cast the first game skill indicated by the first game skill icon in response to the trigger operation on the first game skill icon.

In the embodiments of this disclosure, the second virtual object is controlled to cast the first game skill indicated by the first game skill icon in response to the trigger operation on the first game skill icon, and the skill effect corresponding to the first game skill is added to a virtual object to which the first game skill is targeted.

In some embodiments, when starting a game scene, the computer device may display the game scene front page, and display the object copy function in the game scene front page. Each virtual object that enters the game scene may use the object copy function on the game scene front page to become familiar with how to use the object copy function. In some embodiments, the computer device enters a game scene, displays the game scene, and obtains a restricted function of the second virtual object in the game scene. The computer device may cancel the display of the restricted function in the game scene; or may display the restricted function in the game scene and set the restricted function to a shielded state, and the restricted function in the shielded state cannot be triggered. For example, if the restricted function is a clothing changing function, the display of the clothing changing function may be canceled in the game scene, for example, canceling the display of a wardrobe of the second virtual object, or the clothing changing function may be set to a shielded state, for example, turning off a wardrobe of the second virtual object, or the clothing changing function of the second virtual object is configured to be untriggerable.

In some embodiments, object update data for a fourth virtual object is obtained, and the display of the fourth virtual object in the game interface in which the second virtual object is located is updated based on the object update data. That is, when the fourth virtual object performs the object copy operation, the computer device in which the second virtual object is located can implement synchronous display and update of the fourth virtual object.

In some embodiments, the computer device may display the original game skill icon of the second virtual object in the skill display region of the game interface in which the second virtual object is located in response to a copy cancel operation for the second virtual object, and switch and display the object image of the second virtual object to the original object image of the second virtual object (that is, the object image of the second virtual object itself). The original game skill icon refers to an icon of the original game skill of the second virtual object. For this process, reference may be made to a related description of the method of triggering step S704 in step S703. In other words, the computer device may reclaim the copied summoned object of the second virtual object, delete the game skill stored in the copy skill storage space, that is, give up all game skills learned through morphing (that is, object copying), delete a shielding mark of the original game skill, and restore the game skill of the second virtual object. The computer device may delete the copy skill effect stored in the copy effect storage space, and add the original skill effect of the second virtual object to the second virtual object. The computer device may obtain the original attribute value of the second virtual object from the copy attribute storage space, and update the object attribute information of the second virtual object based on the original attribute value. The computer device may delete the copy gain information generated by the second virtual object in the copy state, and add the original gain information of the second virtual object to the second virtual object. To implement restoring of the game data of the second virtual object, this process may also be implemented by the server. The server implements restoring of the game data of the second virtual object by performing the foregoing steps, and transmits a full data packet of the second virtual object after the game data is restored to the computer device. The computer device updates the second virtual object based on the full data packet.

In some embodiments, the copy cancel function may not be integrated in a game battle. The copy cancel function is configured for triggering a copy cancel operation to implement the morphing and restoration of the virtual object, that is, a player cannot actively restore during the game battle, in other words, the player cannot actively trigger a process of the second virtual object to restore the original game data. This also leads to a fact that in the game battle, since the object copy function is transitive, and the virtual object cannot actively restore the original game data, as the game battle is performed and the object copy function is triggered, a quantity of object types (that is, a game character type) that can be copied by the virtual object participating in the game battle decreases. For example, in the virtual objects participating in the game battle, there is only one virtual object of the healing character type (for example, a healer). If the virtual object of the healing character type morphs into another object type (such as a carry character type), in this case, in the virtual objects participating in the game battle, there is no longer be a virtual object of the healing character type. In this way, in the game battle, the object types owned by the virtual objects participating in the game battle and the timing and sequence of triggering the object copy function need to be comprehensively considered, so that performing the game battle needs a certain game strategy. For example, if some virtual objects are used as copy templates (which may be referred to as template virtual objects), this part of the virtual objects do not trigger the object copy function, and another virtual object may trigger the object copy function for the template virtual object when needed. Alternatively, for example, a virtual object (which may be referred to as a key virtual object) of an object type that is indispensable in the game battle does not trigger the object copy function, or before the object copy function is triggered, another virtual object is morphed into the object type of the key virtual object to retain the indispensable object type and ensure a normal progress of the game. In other words, an overall planning of the game character type needs to be implemented, and a player needs to coordinate the timing and sequence of triggering the object copy function of each virtual object to ensure a normal progress of the game, thereby improving the challenge of the game battle, improving the playability and interest of the game, and improving the interactivity of the game.

In the embodiments of this disclosure, a first game skill icon may be displayed in a skill display region of a game interface in which a second virtual object is located in response to an object copy operation on a first virtual object, where the first game skill icon refers to an icon of the first game skill associated with the first virtual object; an object image of the second virtual object may be switched to a first object image for display, where the first object image refers to an object image of the first virtual object; and in response to a trigger operation on the first game skill icon, the second virtual object having the first object image is controlled to cast the first game skill. Through the foregoing process, the second virtual object (that is, a virtual object controlled by a player) may morph into any other virtual object (that is, the first virtual object) through the object copy operation when participating in a game battle. When a quantity of participant players is limited, the second virtual object can still morph into a virtual object of any object type, so that a balance between different object types in the game battle is implemented, and requirements for players of various object types in the game battle are satisfied, thereby improving the playability and content richness of a game, and also improving utilization of hardware resources of a computer device. In addition, a copy function between different virtual objects is added, so that game skills of other virtual objects are experienced and object images thereof are used, thereby improving the diversity and interactivity of a game.

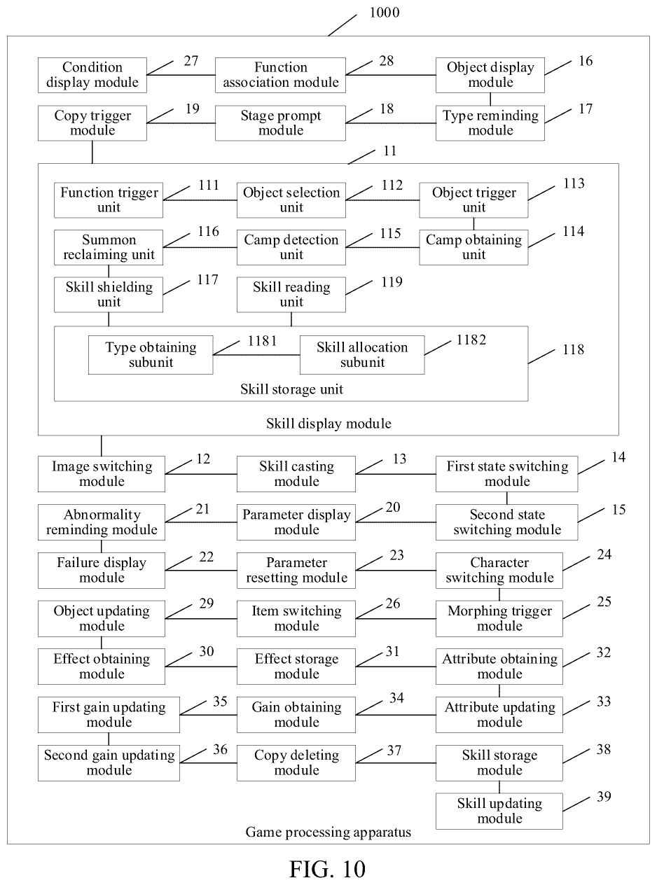

In some embodiments, referring to FIG. 10, FIG. 10 is a schematic diagram of a game processing apparatus according to an embodiment of this disclosure. The game processing apparatus may be a computer program (including program code) run on a computer device. For example, the game processing apparatus may be an application software, and the apparatus may be configured to perform the corresponding steps in the method provided in the embodiments of this disclosure. As shown in FIG. 10, the game processing apparatus 1000 may be configured as the computer device in the embodiment corresponding to FIG. 3. In some embodiments, the apparatus may include: a skill display module 11, an image switching module 12, and a skill casting module 13.

The skill display module 11 is configured to respond to an object copy operation on a first virtual object, and display a first game skill icon in a skill display region of a game interface in which a second virtual object is located, the first game skill icon referring to an icon of a first game skill associated with the first virtual object.

The image switching module 12 is configured to switch an object image of the second virtual object to a first object image for display, the first object image referring to an object image of the first virtual object.

The skill casting module 13 is configured to control, in response to a trigger operation on the first game skill icon, the second virtual object having the first object image to cast the first game skill.

The object copy operation on the first virtual object includes a trigger operation on an object copy function and a select operation on the first virtual object; and

The skill display module 11 includes a function trigger unit 111 and an object selection unit 112.

The function trigger unit 111 is configured to display candidate virtual objects in response to the trigger operation on the object copy function, where the candidate virtual object refers to a virtual object in a same game camp as the second virtual object.

The object selection unit 112 is configured to display, in response to the select operation on the first virtual object in the candidate virtual objects, the first game skill icon in the skill display region of the game interface in which the second virtual object is located.

The object copy operation on the first virtual object includes a trigger operation on the first virtual object and a trigger operation on the object copy function.

The skill display module 11 includes an object trigger unit 113.

The object trigger unit 113 is configured to display, in response to the trigger operation on the first virtual object, candidate functions associated with the first virtual object, where the candidate function refers to a function of the second virtual object for a trigger permission of the first virtual object.

The function trigger unit 111 is further configured to display, in response to the trigger operation on the object copy function in the candidate functions, the first game skill icon in the skill display region of the game interface in which the second virtual object is located.

The apparatus 1000 further includes a first state switching module 14 and a second state switching module 15.

The first state switching module 14 is configured to switch a display state of the object copy function to a cool down state, and display a remaining cool down time of the object copy function in association with the object copy function.

The second state switching module 15 is configured to switch, in a case that the remaining cool down time is a cool down end time, the display state of the object copy function to a working state.

The apparatus 1000 further includes an object display module 16 and a type reminding module 17.

The object display module 16 is configured to display a first game scene in response to a startup operation on the first game scene, and display a third virtual object in the first game scene, where the third virtual object refers to a virtual object in a different game camp from the second virtual object.

The type reminding module 17 is configured to display a copy object type reminder message for the third virtual object in the first game scene, where an object type of the first virtual object is a copy object type indicated by the copy object type reminder message.

The apparatus 1000 further includes a stage prompt module 18 and a copy trigger module 19.

The stage prompt module 18 is configured to display, in response to a startup operation on a second game scene, a game stage included in the second game scene and a key object type prompt message for the game stage.

The copy trigger module 19 is configured to display the second game scene in response to a confirm operation on the second game scene, and during the game stage, respond to the object copy operation on the first virtual object, where an object type of the first virtual object is a key object type indicated by the key object type prompt message for the game stage.

The apparatus 1000 further includes a parameter display module 20, an abnormality reminding module 21, a failure display module 22, and a parameter resetting module 23.

The parameter display module 20 is configured to display a first energy parameter of the second virtual object in association with the second virtual object.

The abnormality reminding module 21 is configured to display, in a case that the first energy parameter is less than or equal to a first energy threshold, an energy abnormality prompt message.

After the responding to an object copy operation on a first virtual object, the failure display module 22 is configured to display, in a case that the first energy parameter is less than a second energy threshold, an object copy failure message; and

the parameter resetting module 23 is configured to display, in a case that the first energy parameter is greater than or equal to the second energy threshold, a reset first energy parameter, and perform the process of displaying a first game skill icon in a skill display region of a game interface in which a second virtual object is located.

The apparatus 1000 further includes a character switching module 24.

The character switching module 24 is configured to switch, in response to a switch operation on a target game character, a game skill icon displayed in the skill display region of the game interface in which the second virtual object is located to a second game skill icon for display, where the second game skill icon refers to an icon of a game skill of the target game character.

The image switching module 12 is further configured to switch the object image of the second virtual object to a target object image corresponding to the target game character for display.

The apparatus 1000 further includes a morphing trigger module 25 and an item switching module 26.

The morphing trigger module 25 is configured to cancel, in response to a morph operation on a target game item, display of a game skill icon displayed in the skill display region.

The item switching module 26 is configured to switch the object image of the second virtual object to an item image of the target game item for display, and display a target game skill icon associated with the morph operation.

The apparatus 1000 further includes a condition display module 27 and a function association module 28.

The condition display module 27 is configured to display a function obtaining condition in response to an obtain operation on the object copy function.

The function association module 28 is configured to associate, in a case that the second virtual object satisfies the function obtaining condition, the object copy function with the second virtual object, where the object copy function is configured for triggering the object copy operation.

The skill display module 11 includes a camp obtaining unit 114 and a camp detection unit 115.

The camp obtaining unit 114 is configured to obtain, in response to the object copy operation on the first virtual object, a camp type of the first virtual object and a camp type of the second virtual object.

The camp detection unit 115 is configured to display, in a case that the camp type of the first virtual object and the camp type of the second virtual object are both a first camp type, the first game skill icon in the skill display region of the game interface in which the second virtual object is located.

The apparatus 1000 further includes an object updating module 29, configured to obtain object update data for a fourth virtual object, and update, based on the object update data, display of the fourth virtual object in the game interface in which the second virtual object is located.

The skill display module 11 includes a summon reclaiming unit 116, a skill shielding unit 117, a skill storage unit 118, and a skill reading unit 119.

The summon reclaiming unit 116 is configured to reclaim, in a case that the second virtual object is in an original state, an original summoned object of the second virtual object in response to the object copy operation on the first virtual object.

The skill shielding unit 117 is configured to create copy skill storage space for the second virtual object, and add a shielding mark to an original game skill of the second virtual object.

The skill storage unit 118 is configured to store a first game skill in the copy skill storage space, where the first game skill refers to a game skill associated with the first virtual object.

The skill reading unit 119 is configured to read the first game skill from the copy skill storage space associated with the second virtual object, and display the first game skill icon of the first game skill in the skill display region of the game interface in which the second virtual object is located.

The skill storage unit 118 includes a type obtaining subunit 1181 and a skill allocation subunit 1182.

The type obtaining subunit 1181 is configured to obtain an object type of the first virtual object and obtain a game skill point possessed by the second virtual object.

The skill allocation subunit 1182 is configured to obtain the first game skill associated with the object type of the first virtual object, allocate the game skill point to the first game skill, and store the first game skill carrying the game skill point in the copy skill storage space.

The apparatus 1000 further includes an effect obtaining module 30 and an effect obtaining module 30.

The effect obtaining module 30 is configured to create copy effect storage space for the second virtual object, and obtain a skill effect corresponding to the first game skill.

The effect storage module 31 is configured to store the skill effect corresponding to the first game skill in the copy effect storage space.

The skill casting module 13 is further configured to control, in response to the trigger operation on the first game skill icon, the second virtual object to cast the first game skill indicated by the first game skill icon, and add the skill effect corresponding to the first game skill to a virtual object to which the first game skill is targeted.

The apparatus 1000 further includes an attribute obtaining module 32 and an attribute updating module 33.

The attribute obtaining module 32 is configured to create copy attribute storage space for the second virtual object, obtain a first attribute value possessed by the second virtual object, and store the first attribute value in the copy attribute storage space.

The attribute updating module 33 is configured to obtain a second attribute value corresponding to an object type of the first virtual object, and update object attribute information of the second virtual object based on the second attribute value.

The apparatus 1000 further includes a gain obtaining module 34 and a first gain updating module 35.

The gain obtaining module 34 is configured to obtain gain information associated with the second virtual object, where the gain information includes first type gain information and second type gain information, and a gain duration of the first type gain information is greater than a gain duration of the second type gain information;

The first gain updating module 35 is configured to delete first gain information associated with an object type of the second virtual object in the second type gain information, and reset second gain information, where the second gain information refers to second type gain information other than the first gain information in the second type gain information.

The second gain updating module 36 is configured to determine third gain information based on an object type of the first virtual object, delete fourth gain information that does not belong to the third gain information in the first type gain information, and add fifth gain information for the second virtual object, where the fifth gain information refers to gain information that belongs to the third gain information and does not belong to the first type gain information.

The apparatus 1000 further includes a copy deleting module 37, a skill storage module 38, and a skill updating module 39.

The copy deleting module 37 is configured to delete, in a case that the second virtual object is in a copy state, a game skill stored in the copy skill storage space of the second virtual object, and delete copy associated data of the second virtual object.

The skill storage module 38 is configured to store the first game skill in the copy skill storage space.

The skill updating module 39 is configured to read the first game skill from the copy skill storage space associated with the second virtual object, and display the first game skill icon of the first game skill in the skill display region of the game interface in which the second virtual object is located.

Embodiments of this disclosure provide a game processing apparatus. The apparatus may be run in a game processing device, and may respond to an object copy operation on a first virtual object, and display a first game skill icon in a skill display region of a game interface in which a second virtual object is located, where the first game skill icon refers to an icon of a first game skill associated with the first virtual object; switch an object image of the second virtual object to a first object image for display, where the first object image refers to an object image of the first virtual object; and control, in response to a trigger operation on the first game skill icon, the second virtual object to cast the first game skill indicated by the first game skill icon. Through the foregoing process, the second virtual object (that is, a player) may morph into any other player (that is, the first virtual object) through the object copy operation when participating in a game battle. When a quantity of participant players is limited, the second virtual object can still morph into a virtual object of any object type, so that a balance between different object types in the game battle is implemented, and requirements for players of various object types in the game battle are satisfied, thereby improving the playability and content richness of a game. In addition, a copy function between different virtual objects is added, so that game skills of other virtual objects are experienced and object images thereof are used, thereby improving the diversity and interactivity of a game.

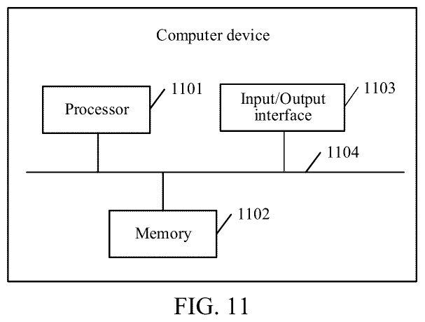

FIG. 11 is a schematic structural diagram of a computer device according to an embodiment of this disclosure. As shown in FIG. 11, the computer device in the embodiments of this disclosure may include: one or more processors 1101, a memory 1102, and an input/output interface 1103. The processor 1101, the memory 1102, and the input/output interface 1103 are connected through a bus 1104. The memory 1102 is configured to store a computer program, where the computer program includes program instructions. The input/output interface 1103 is configured to receive data and output data, for example, is configured to perform data interaction between various computer devices, or is configured to perform data interaction between the computer device and a server. The processor 1101 is configured to perform program instructions stored in the memory 1102.

The processor 1101 is located in a game processing device and may perform the following operations:
responding to an object copy operation on a first virtual object, and displaying a first game skill icon in a skill display region of a game interface in which a second virtual object is located, the first game skill icon referring to an icon of a first game skill associated with the first virtual object;
switching an object image of the second virtual object to a first object image for display, the first object image referring to an object image of the first virtual object; and
controlling, in response to the trigger operation on the first game skill icon, the second virtual object having the first object image to cast the first game skill indicated by the first game skill icon.

In some feasible implementations, the processor 1101 may be a central processing unit (CPU). The processor may further be another general-purpose processor, a digital signal processor (DSP), an application specific integrated circuit (ASIC), a field-programmable gate array (FPGA), or another programmable logic device, a discrete gate or a transistor logic device, a discrete hardware component, or the like. The general-purpose processor may be a microprocessor, or the processor may be any conventional processor, or the like.

The memory 1102 may include a read-only memory and a random access memory, and provides the processor 1101 and the input/output interface 1103 with instructions and data. A part of the memory 1102 may further include a non-volatile random access memory. For example, the memory 1102 may further store information about a device type.

During specific implementation, the computer device may perform the implementations provided in the steps in FIG. 3 through built-in functional modules of the computer device. For details, reference may be made to the implementations provided in the steps in FIG. 3, and details are not described herein again.

The embodiments of this disclosure provide a computer device, including: a processor, an input/output interface, and a memory. The processor obtains a computer program in the memory, perform steps of the method shown in FIG. 3, and perform game processing operations. In the embodiments of this disclosure, a first game skill icon may be displayed in a skill display region of a game interface in which a second virtual object is located in response to an object copy operation on a first virtual object, where the first game skill icon refers to an icon of the first game skill associated with the first virtual object; an object image of the second virtual object may be switched to a first object image for display, where the first object image refers to an object image of the first virtual object; and in response to a trigger operation on the first game skill icon, the second virtual object having the first object image is controlled to cast the first game skill. Through the foregoing process, the second virtual object (that is, a virtual object controlled by a player) may morph into any other virtual object (that is, the first virtual object) through the object copy operation when participating in a game battle. When a quantity of participant players is limited, the second virtual object can still morph into a virtual object of any object type, so that a balance between different object types in the game battle is implemented, and requirements for players of various object types in the game battle are satisfied, thereby improving the playability and content richness of a game. In addition, a copy function between different virtual objects is added, so that game skills of other virtual objects are experienced and object images thereof are used, thereby improving the diversity and interactivity of a game.

The embodiments of this disclosure further provide a computer-readable storage medium, such as a non-transitory computer-readable storage medium, the computer-readable storage medium storing a computer program, and the computer program being adapted to be loaded and executed by the processor to perform the game processing method provided by each step in FIG. 3. For a specific implementation, refer to each step in FIG. 3. Details are not described herein again. In addition, the description of beneficial effects of the same method is not described herein again. For technical details that are not disclosed in the embodiments of the computer-readable storage medium of this disclosure, refer to the method embodiments of this disclosure. In an example, the computer program may be deployed to be executed on a computer device, or deployed to be executed on a plurality of computer devices at a same location, or deployed to be executed on a plurality of computer devices that are distributed in a plurality of locations and interconnected by using a communication network.

The computer-readable storage medium may be a game processing apparatus provided in any one of the foregoing embodiments or an internal storage unit of the computer device, for example, a hard disk or a main memory of the computer device. The computer-readable storage medium may alternatively be an external storage device of the computer device, for example, a removable hard disk, a smart media card (SMC), a secure digital (SD) card, or a flash card equipped on the computer device. In some embodiments, the computer-readable storage medium may further include both an internal storage unit and an external storage device of the computer device. The computer-readable storage medium is configured to store the computer program and another program and data that are required by the computer device. The computer-readable storage medium may further be configured to temporarily store data that has been outputted or data to be outputted.

The embodiments of this disclosure further provide a computer program product or a computer program, the computer program product or the computer program including computer instructions, the computer instructions being stored in a computer-readable storage medium. A processor of the computer device reads the computer instructions from the computer-readable storage medium, and the processor performs the computer instructions, so that the computer device performs the method provided in various optional manners in FIG. 3. In this way, the second virtual object (that is, a player) may be morphed into any other player (that is, the first virtual object) through the object copy operation when participating in a game battle. When a quantity of participant players is limited, the second virtual object can still morph into a virtual object of any object type, so that a balance between different object types in the game battle is implemented, and requirements for players of various object types in the game battle are satisfied, thereby improving the playability and content richness of the game. In addition, a copy function between different virtual objects is added, so that game skills of other virtual objects are experienced and object images thereof are used, thereby improving the diversity and interactivity of a game.

In the specification, claims, and accompanying drawings of embodiments of this disclosure, the terms “first” and “second” are intended to distinguish between different objects but do not indicate a particular order. In addition, terminologies “comprise” and any variations thereof are intended to indicate non-exclusive inclusion. For example, a process, method, apparatus, product, or device that includes a series of steps or modules is not limited to the listed steps or units; and instead, further includes a step or module that is not listed, or further includes another step or unit that is intrinsic to the process, method, apparatus, product, or device.

A person of ordinary skill in the art may be aware that, in combination with the examples described in the embodiments disclosed in this specification, units and algorithm steps can be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

The method and the related apparatus provided in the embodiments of this disclosure are described with reference to method flowcharts and/or schematic structural diagrams provided in the embodiments of this disclosure. Specifically, computer program instructions may be used to implement each process and/or each block in the method flowcharts and/or the schematic structural diagrams and a combination of a process and/or a block in the flowcharts and/or the block diagrams. These computer program instructions may be provided to a general-purpose computer, a dedicated computer, an embedded processor, or a processor of another programmable game processing device to generate a machine, so that the instructions executed by the computer or the processor of the another programmable game processing device generate an apparatus for implementing a specific function in one or more procedures in the flowcharts and/or in one or more blocks in the schematic structural diagrams. These computer program instructions may alternatively be stored in a computer-readable memory that can instruct a computer or another programmable game processing device to work in a specific manner, so that the instructions stored in the computer-readable memory generate an artifact that includes an instruction apparatus. The instruction apparatus implements a specific function in one or more procedures in the flowcharts and/or in one or more blocks in the schematic structural diagrams. These computer program instructions may further be loaded onto a computer or another programmable game processing device, so that a series of operations and steps are performed on the computer or the another programmable device, thereby generating computer-implemented processing. Therefore, the instructions executed on the computer or the another programmable device provide steps for implementing a specific function in one or more procedures in the flowcharts and/or in one or more blocks in the schematic structural diagrams.

Examples of beneficial effects of the embodiments of this disclosure include:

1. A first game skill icon may be displayed in a skill display region of a game interface in which a second virtual object is located in response to an object copy operation on a first virtual object, where the first game skill icon refers to an icon of the first game skill associated with the first virtual object; an object image of the second virtual object may be switched to a first object image for display, where the first object image refers to an object image of the first virtual object; and in response to a trigger operation on the first game skill icon, the second virtual object having the first object image is controlled to cast the first game skill. Through the foregoing process, the second virtual object (that is, a virtual object controlled by a player) may morph into any other virtual object (that is, the first virtual object) through the object copy operation when participating in a game battle. When a quantity of participant players is limited, the second virtual object can still morph into a virtual object of any object type, so that a balance between different object types in the game battle is implemented, and requirements for players of various object types in the game battle are satisfied, thereby improving the playability and content richness of a game, and also improving utilization of hardware resources of a computer device. In addition, a copy function between different virtual objects is added, so that game skills of other virtual objects are experienced and object images thereof are used, thereby improving the diversity and interactivity of a game.

2. Since the copy object type reminder message is configured for prompting the second virtual object to trigger an object copy operation on the first virtual object, the object type of the first virtual object is the copy object type indicated by the copy object type reminder message, so that the second virtual object is reminded to switch to the virtual object of the copy object type indicated by the copy object type reminder message through the copy object type reminder message, to cope with the attack damage caused by the corresponding attack information of the third virtual object, which effectively improves the game skill of the second virtual object, implements a balance between different object types in a game battle, satisfies requirements for players of various object types in the game battle, and improves the playability and content richness of the game.

3. The target game item may refer to a scene item, such as a flower, a tree, a table, a chair, or an ornament. Alternatively, the computer device starts a target game scene, and displays a target game skill icon. The target game skill icon may include a morph function icon, a moving icon, a direction changing icon, and the like, and in response to a morph operation on a target game item, the object image of the second virtual object is switched to an item image of the target game item for display. By switching the object image of the second virtual object to the item image of the target game item for display, the virtual object may morph into a scene item and merge into the target game scene, and a hide-and-seek mini-game may be implemented. By adding such mini-games to the game, the content richness and diversity of the game are improved, and the interest of the game is increased.

4. When no game battle needs to be performed, the second virtual object may also morph into the first virtual object through the foregoing process, to experience the game skill of the first virtual object, or experience the object image of the first virtual object, thereby improving the content richness and interest of the game. In addition, each virtual object may further interact with another virtual object through the foregoing process, thereby improving the interactivity of the game.

5. To trigger the object copy function, game data of one virtual object needs to be fully updated to game data of another virtual object, original game data of the virtual object performing morphing needs to be retained, and other virtual objects in the same game scene also need to synchronize game data of a morphed virtual object performing morphing in time, that is, implementation of the object copy function is not just a simple update of one virtual object. Therefore, a cool down time may be added for the object copy function. When the cool down ends (that is, the remaining cool down time is the cool down end time), the object copy function is provided again, so that different virtual objects may synchronize data update caused by the object copy function in time, which reduces game data disorder caused by continuous morphing, ensures normal operation of the game, and improves function experience and function operation effects of the object copy function.

6. Respond to a slide operation from the first virtual object to the object copy function, and display the first game skill icon in the skill display region of the game interface in which the second virtual object is located. In this manner, the player may directly slide from a virtual object that the player intends to copy (that is, the first virtual object) to the object copy function to trigger the object copy function for the first virtual object. The operation is simple and fast, especially in a game battle, which may easily implement copying between virtual objects and save a trigger time of the object copy function. In addition, due to the time continuity of the game battle, that is, pausing cannot be performed, triggering the object copy function in this manner can effectively save a morphing time, reduce the time for triggering the object copy function, and improve the game interaction efficiency.

7. When the game scene in which the second virtual object is located changes, for example, a game map changes or a game battle changes, the object attribute information of the second virtual object may be updated based on the first attribute value to improve the security of the game data and avoid a serious attribute confusion problem.

8. The copy effect storage space may be created for the second virtual object, the skill effect corresponding to the first game skill is obtained, and the skill effect corresponding to the first game skill is stored to the copy effect storage space. To avoid adding/deleting a certain skill effect by mistake when copying/canceling to copy an object, copy effect storage space may be blazed. The copy effect storage space is equivalent to a cache. The skill effect (that is, a skill effect obtained by morphing, which is equivalent to a temporary skill effect) corresponding to the first game skill may be stored in the copy effect storage space, so that an original skill effect of an original game skill of the second virtual object is not affected and security and reliability of game data is ensured. The skill effect is configured for adding an additional effect to the corresponding first game skill. For example, if a first game skill is an attack skill and a skill effect of the first game skill is deceleration, when the first game skill carrying the skill effect is cast, attack damage and a deceleration effect is caused to a virtual object to which the first game skill is targeted.

9. The original game data of the second virtual object may be stored, and stability of the game data of the second virtual object may be maintained, so that when the game data of the second virtual object itself does not change, the copy effect is only achieved at an experience level of the second virtual object. When the second virtual object exits the copy state, the original game data of the second virtual object may be restored, which ensures the essence of the game data.

10. The copy cancel function may not be integrated in a game battle. The copy cancel function is configured for triggering a copy cancel operation to implement the morphing and restoration of the virtual object, that is, a player cannot actively restore during the game battle, in other words, the player cannot actively trigger a process of the second virtual object to restore the original game data. This also leads to a fact that in the game battle, since the object copy function is transitive, and the virtual object cannot actively restore the original game data, as the game battle is performed and the object copy function is triggered, a quantity of object types (that is, a game character type) that can be copied by the virtual object participating in the game battle decreases. For example, in the virtual objects participating in the game battle, there is only one virtual object of the healing character type (for example, a healer). If the virtual object of the healing character type morphs into another object type (such as a carry character type), in this case, in the virtual objects participating in the game battle, there is no longer be a virtual object of the healing character type. In this way, in the game battle, the object types owned by the virtual objects participating in the game battle and the timing and sequence of triggering the object copy function need to be comprehensively considered, so that performing the game battle needs a certain game strategy. For example, if some virtual objects are used as copy templates (which may be referred to as template virtual objects), this part of the virtual objects do not trigger the object copy function, and another virtual object may trigger the object copy function for the template virtual object when needed. Alternatively, for example, a virtual object (which may be referred to as a key virtual object) of an object type that is indispensable in the game battle does not trigger the object copy function, or before the object copy function is triggered, another virtual object is morphed into the object type of the key virtual object to retain the indispensable object type and ensure a normal progress of the game. In other words, an overall planning of the game character type needs to be implemented, and a player needs to coordinate the timing and sequence of triggering the object copy function of each virtual object to ensure a normal progress of the game, thereby improving the challenge of the game battle, improving the playability and interest of the game, and improving the interactivity of the game.

What is disclosed above is merely examples of embodiments of this disclosure, which are not intended to limit the protection scope of this disclosure. Equivalent variations made in accordance with the aspects of this disclosure shall fall within the scope of this disclosure.

What is claimed is:

1. A game processing method, comprising:
receiving a request from a user of a second virtual object to perform an object copy function on a first virtual object;
displaying, by processing circuitry, a first game skill control element in a control region of the second virtual object in a game interface based on the request, the first game skill control element being associated with a first game skill of the first virtual object;
switching a display of the second virtual object in the game interface from a second object image of the second virtual object to a first object image of the first virtual object based on the request; and
controlling the second virtual object to perform the first game skill based on a user interaction with the first game skill control element in the control region of the second virtual object in the game interface.

2. The method according to claim 1, wherein the first game skill and the first object image of the first virtual object is copied from a third virtual object.

3. The method according to claim 1, wherein
the displaying the first game skill control element comprises:
displaying at least one candidate virtual object that is in a same game camp as the second virtual object when the request to perform the object copy function is received;
receiving a selection of the first virtual object from the at least one candidate virtual object; and
displaying, when the first virtual object is selected from the candidate virtual objects, the first game skill control element in the control region of the second virtual object in the game interface.

4. The method according to claim 1, wherein
the displaying the first game skill control element comprises:
displaying at least one candidate function that is permitted to be performed by the second virtual object on the first virtual object; and
displaying, when the object copy function is selected from the candidate functions, the first game skill control element in the control region of the second virtual object in the game interface.

5. The method according to claim 3, further comprising:
switching a display state of the object copy function to a unavailable state;
displaying a remaining cool down time of the object copy function in association with the object copy function; and
switching the display state of the object copy function to an available state when the remaining cool down time reaches a cool down end time.

6. The method according to claim 1, further comprising:
displaying a first game scene;
displaying a third virtual object in the first game scene, the third virtual object being in a different game camp from the second virtual object; and
displaying a copy object type reminder message for the third virtual object in the first game scene, the copy object type reminder message indicating an object type of the first virtual object.

7. The method according to claim 1, further comprising:
displaying a game stage in a second game scene and a key object type notification message for the game stage,
wherein an object type of the first virtual object is a key object type indicated by the key object type notification message for the game stage.

8. The method according to claim 1, further comprising:
displaying a first energy parameter of the second virtual object in association with the second virtual object;
displaying an energy abnormality notification message when the first energy parameter is less than or equal to a first energy threshold;
displaying, when the first energy parameter is less than a second energy threshold, an object copy failure message; and
when the first energy parameter is greater than or equal to the second energy threshold, displaying a reset first energy parameter, and
performing the displaying the first game skill control element in the control region of the second virtual object in the game interface.

9. The method according to claim 1, further comprising:
switching, when a switch operation is performed on a target game character, a display of game skill control element in the control region of the second virtual object in the game interface to a second game skill control element that is associated with a game skill of the target game character; and
switching the display of the second object image of the second virtual object to a target object image corresponding to the target game character.

10. The method according to claim 1, further comprising:
canceling, when a morph operation is performed on a target game item, display of a game skill control element displayed in the control region;
switching the display of the second object image of the second virtual object to an item image of the target game item; and
displaying a target game skill control element associated with the morph operation.

11. The method according to claim 1, further comprising:
displaying the object copy function with the second virtual object in the game interface when the second virtual object satisfies a function obtaining condition.

12. The method according to claim 1, wherein the displaying the first game skill control element comprises:
obtaining an association type of the first virtual object and an association type of the second virtual object, when the object copy function is performed on the first virtual object; and
displaying the first game skill control element in the control region of the second virtual object in the game interface when the association type of the first virtual object and the association type of the second virtual object are both a first association type.

13. The method according to claim 1, further comprising:
obtaining object update data for a fourth virtual object that performs the object copy function; and
updating, based on the object update data, display of the fourth virtual object in the game interface.

14. The method according to claim 1, further comprising:
storing the first game skill in a copy skill storage space; and
reading the first game skill from the copy skill storage space associated with the second virtual object.

15. The method according to claim 14, wherein the storing the first game skill in the copy skill storage space comprises:
obtaining an object type of the first virtual object and obtaining a game skill point of the second virtual object; and
obtaining the first game skill associated with the object type of the first virtual object, allocating the game skill point to the first game skill, and storing the first game skill carrying the game skill point in the copy skill storage space.

16. The method according to claim 14, further comprising:
when the second virtual object is in a copy state, deleting a game skill stored in the copy skill storage space of the second virtual object, and deleting copy associated data of the second virtual object.

17. The method according to claim 1, further comprising:
obtaining a skill effect corresponding to the first game skill;
storing the skill effect corresponding to the first game skill in a copy effect storage space; and
the controlling includes adding the skill effect corresponding to the first game skill to a virtual object to which the first game skill is targeted.

18. The method according to claim 1, further comprising:
obtaining a first attribute value of the second virtual object;
storing the first attribute value in a copy attribute storage space;
obtaining a second attribute value corresponding to an object type of the first virtual object; and
updating object attribute information of the second virtual object based on the second attribute value.

19. A game processing apparatus, comprising:
processing circuitry configured to:
receive a request from a user of a second virtual object to perform a object copy function on a first virtual object;
display a first game skill control element in a control region of the second virtual object in a game interface based on the request, the first game skill control element being associated with a first game skill of the first virtual object;
switching a display of the second virtual object in the game interface from a second object image of the second virtual object to a first object image of the first virtual object based on the request; and
controlling the second virtual object to perform the first game skill based on a user interaction with the first game skill control element in the control region of the second virtual object in the game interface.

20. A non-transitory computer-readable storage medium, storing instructions which when executed by a processor cause the processor to perform:
receiving a request from a user of a second virtual object to perform a object copy function on a first virtual object;
displaying a first game skill control element in a control region of the second virtual object in a game interface based on the request, the first game skill control element being associated with a first game skill of the first virtual object;
switching a display of the second virtual object in the game interface from a second object image of the second virtual object to a first object image of the first virtual object based on the request; and
controlling the second virtual object to perform the first game skill based on a user interaction with the first game skill control element in the control region of the second virtual object in the game interface.
